(19) United States
(12) Patent Application Publication
(10) Pub. No.: US 2025/0273037 A1
(43) Pub. Date: Aug. 28, 2025

(54) INTEGRATED MODULAR SEATING SYSTEMS FOR ELECTRONIC GAMING SYSTEMS AND METHODS

(71) Applicant: Aristocrat Technologies, Inc., Las Vegas, NV (US)

(72) Inventors: Paul Barker, Las Vegas, NV (US); Rajendrasinh Jadeja, Las Vegas, NV (US); Joseph Kaminkow, Las Vegas, NV (US); Frank Rodriguez, Las Vegas, NV (US); Charles Miller, SR., Henderson, NV (US); Stephen Shaffer, JR., Las Vegas, NV (US); Timothy Barbour, Nolensville, TN (US)

(21) Appl. No.: 19/056,580

(22) Filed: Feb. 18, 2025

Related U.S. Application Data
(60) Provisional application No. 63/557,272, filed on Feb. 23, 2024.

(51) Int. Cl. G07F 17/32

(52) U.S. Cl. CPC G07F 17/3216; G07F 17/3209; G07F 17/3211

(57) ABSTRACT

Seating systems for electronic gaming on electronic gaming machines are provided. Some systems have a seat, a kiosk directly or indirectly coupled to the seat, and an operating console rotatably coupled to the kiosk and having a button deck, a first end piece detachably coupled to a first end of the operating console and having a first button, and a second end piece detachably coupled to a second end of the operating console, opposite the first end, and having a second button or a display. The first and second end pieces are configured to be detached from the operating console, the operating console is configured to receive a third end piece, the operating console is configured to be rotated between first and second orientations, and the button deck and the first and second end pieces are configured to be communicatively coupled to a game controller of the electronic gaming machine.

### RELATED APPLICATIONS

The present application claims priority to U.S. Provisional Patent Application No. 63/557,272, filed Feb. 23, 2024, and titled “INTEGRATED MODULAR SEATING ASSEMBLY FOR ELECTRONIC GAMING SYSTEMS AND METHODS,” which is hereby incorporated by reference in its entirety and for all purposes.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Typical gaming systems employ user interfaces, monitors, and/or display devices installed on a cabinet to display gaming information and/or games to a player. Some of these gaming systems may include other apparatuses such as chairs for accommodating the player to interact or interface with the gaming systems. These other apparatuses are generally not designed, equipped, furnished, or personalized for the player, the games being offered, or the player comfort in mind, let alone matching any specific game characteristics.

As such, players may be unable to fully experience any or all impacts that gaming systems may be able to offer with these ordinary accommodation apparatuses or gaming systems. Further, when an electronic gaming system has related furnishings, e.g., chairs, installed or fixed on a casino floor, i.e., in the field, when changing any game offerings from a first game to a new game a gaming manufacturer may have to entirely remove the electronic gaming system including the furnishings from the floor to remove artwork or artworks related to the first game, replace the artwork for the new game, and return and re-install the electronic gaming system on the floor while complying with any security protocols for secure gaming.

The removal, replacement, and re-installation of seating for electronic gaming system involves processes that may be time consuming and be inflexible in varying electronic gaming system capabilities, and, in turn, cause a casino operator to incur cost from undergoing the processes and from the loss of game operation on the casino floor. Manual artwork replacement on seating may also present bottlenecks on removal, replacement, and re-installation when it requires the electronic gaming systems to be removed from the casino floor.

As such, conventional seating for gaming machines remains problematic. A modular seating assembly system for electronic gaming systems that offers a more complete game system immersion, greater flexibility in audio and display configurations, game play ergonomics and control, and less time consuming removal, replacement and re-installation when an electronic gaming system module is to be replaced, will be a welcome innovation for gaming establishments, e.g., casinos, that employ such gaming technology and the like.

### SUMMARY

Details of one or more implementations of the subject matter described in this specification are set forth in the accompanying drawings and the description below. Other features, aspects, and advantages will become apparent from the description, the drawings, and the claims. The following, non-limiting implementations are considered part of the disclosure; other implementations will be evident from the entirety of this disclosure and the accompanying drawings as well.

In some implementations, a seating system for electronic gaming on an electronic gaming machine may be provided. The seating system may have a seat with a seating surface and a backrest, a kiosk directly or indirectly coupled to the seat, and an operating console rotatably coupled to the kiosk and having a button deck, a first end piece detachably coupled to a first end of the operating console and having a first button, and a second end piece detachably coupled to a second end of the operating console, opposite the first end, and having a second button or a display. The first end piece and the second end piece may be configured to be detached from the operating console, the operating console may be configured to receive a third end piece at the first end or the second end when the first end piece or the second end piece, respectively, has been detached, the operating console may be configured to be rotated between a first orientation and a second orientation 90 degrees apart from the first orientation, and the button deck, the first end piece, and the second end piece may be configured to be communicatively coupled to a game controller of the electronic gaming machine.

In some implementations, the button deck, the first end piece, the second end piece, or a combination thereof may be configured to receive input from a user, and provide information related to the input from the user to the game controller of the electronic gaming machine.

In some implementations, the operating console may be further configured to translate along a translation axis.

In some such implementations, the translation axis may be perpendicular to the axis of rotation.

In some such implementations, the operating console may be configured to translate along the translation axis without the use of tools.

In some such implementations, the translation axis may have a first end and a second end, the second end may be closer to the seat than the first end, and the operating console may be closer to the seat when positioned at the second end than when positioned at the first end.

In some implementations, the second end piece may be oriented at a non-parallel angle with respect to the button deck.

In some implementations, the first button may be a physical button.

In some implementations, the second end piece may have a display that is configured to display player related information.

In some implementations, the system may further have a display of the electronic gaming machine coupled to the kiosk and/or the seat, and the game controller that is configured to cause a game instance to be displayed on the display.

In some implementations, the electronic gaming machine may be without any physical coupling to the seat or the kiosk.

In some implementations, the seat may further have at least one display panel configured to display game information, attractions, a portion of a game instance, images, videos, or a combination thereof.

In some such implementations, the system may further have a controller communicatively coupled with the game controller. The controller may be configured to display, based on an outcome of a game instance on the electronic gaming machine, game information, attractions, a portion of a game instance, images, videos, or a combination thereof.

In some further such implementations, the game information, attractions, a portion of a game instance, images, videos, or a combination thereof displayed based on the outcome of the game instance may be related to a game theme of the game instance.

In some such implementations, the game information may include one or more wager amounts of the game instance.

In some such implementations, the at least one display panel may have one or more curved flexible display panel, the seat may further include at least one side panel adjacent to the seating surface and the backrest, and the curved flexible display panel may be positioned on the side panel.

In some further such implementations, the curved flexible display panel may have a flexible liquid crystal display (LCD), a flexible electrophoretic display (EPD), a flexible organic light emitting diode (OLED) display, a rollable TFT-driven OLED display, or an electronic paper display.

In some further such implementations, the side panel may include an armrest, and the curved flexible display panel may be positioned on the armrest.

In some implementations, a seating system for electronic gaming on an electronic gaming machine may be provided. The seating system may have a seat with a seating surface, a backrest, and at least one armrest adjacent to the seating surface and the backrest, at least one flexible curved display panel on the at least one armrest, a kiosk directly or indirectly coupled to the seat, and an operating console coupled to the kiosk and having a button deck configured to be communicatively coupled to a game controller of the electronic gaming machine. The at least one flexible curved display panel may be configured to display game information, attractions, a portion of a game instance, images, videos, or a combination thereof.

In some implementations, the system may further have a controller communicatively coupled with the game controller. The controller may be configured to display, based on an outcome of a game instance on the electronic gaming machine, the game information, attractions, a portion of a game instance, images, videos, or a combination thereof.

Additional aspects will be set forth in the detailed description which follows, and, in part, will be apparent from the disclosure, or may be learned by practice of the disclosed embodiments and/or the claimed subject matter.

The foregoing general description and the following detailed description are illustrative and explanatory and are intended to provide further explanation of the claimed subject matter.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A-4G illustrate different views of a first version of a seating system for electronic gaming.

FIG. 5 illustrates different views of a second version of a seating system for electronic gaming.

FIG. 6 illustrates a third version of a seating system for electronic gaming.

FIG. 7 illustrates different views of a fourth version of a seating system for electronic gaming.

FIGS. 8A and 8B illustrate different views of a fifth version of a seating system for electronic gaming.

FIGS. 9A and 9B illustrate different views of a sixth version of a seating system for electronic gaming.

FIG. 10 illustrates different views of a seventh version of a seating system for electronic gaming.

FIGS. 11A and 11B illustrate exploded views of another seating system for electronic gaming.

FIGS. 12A-12F illustrate different views of yet another version of a seating system for electronic gaming.

FIG. 13 illustrates an operating console for of the seating system of FIG. 12A in multiple configurations.

FIG. 14 illustrates the seating system of FIGS. 12A-12F in another configuration.

FIGS. 15A-15C illustrate different views of an electronic gaming system.

FIGS. 16A-16C illustrate different views of an electronic gaming system.

FIGS. 17A-17C illustrate off-angle views of the kiosk and the operating console in various configurations.

### DETAILED DESCRIPTION

Examples in this disclosure provide seating systems for electronic gaming machines that may include an immersive and modular gaming seat, or bench which may be used synonymously with “seat”. The seat may have a seating surface, seat back, a kiosk, and an operating console that is configured to receive user input, to rotate, and that has end pieces detachably coupled to a button deck of the operating console. The end pieces may also be configured to receive a user's input, which may include having a button, or to display information to a user. The operating console is communicatively connected, or coupled, to the EGM to communicate the user's input received at the operating console to the EGM. The seating system may be physically separate, or uncoupled, from the EGM in some instances, and may be physically coupled to the EGM in other instances. The kiosk may be in data communication with the seat and may include one or more projection devices to project gaming information or games from the kiosk. The bench may also include a swivel base that allows the bench to rotate with respect to a reference point. The seat may also include different modular panels that may include static graphics or artwork and may be modularly replaced with like panels that include flexible LCD or LED display panels. This may include flexible displays positioned on the side panels or armrests of the seat. Not only does the bench provide sounds and lights, but the bench may also be able to provide massaging service to a player while the player is seated. Moreover, the bench may provide the ability to connect to newly designed button deck style stand-alone kiosks with Cinema style LCD options, or in front of a large LED wheel display, as well as the ability to plug directly into standard gaming cabinets. The ability of the bench to connect to standard gaming cabinets is similar to how gaming chairs are currently connected in the field.

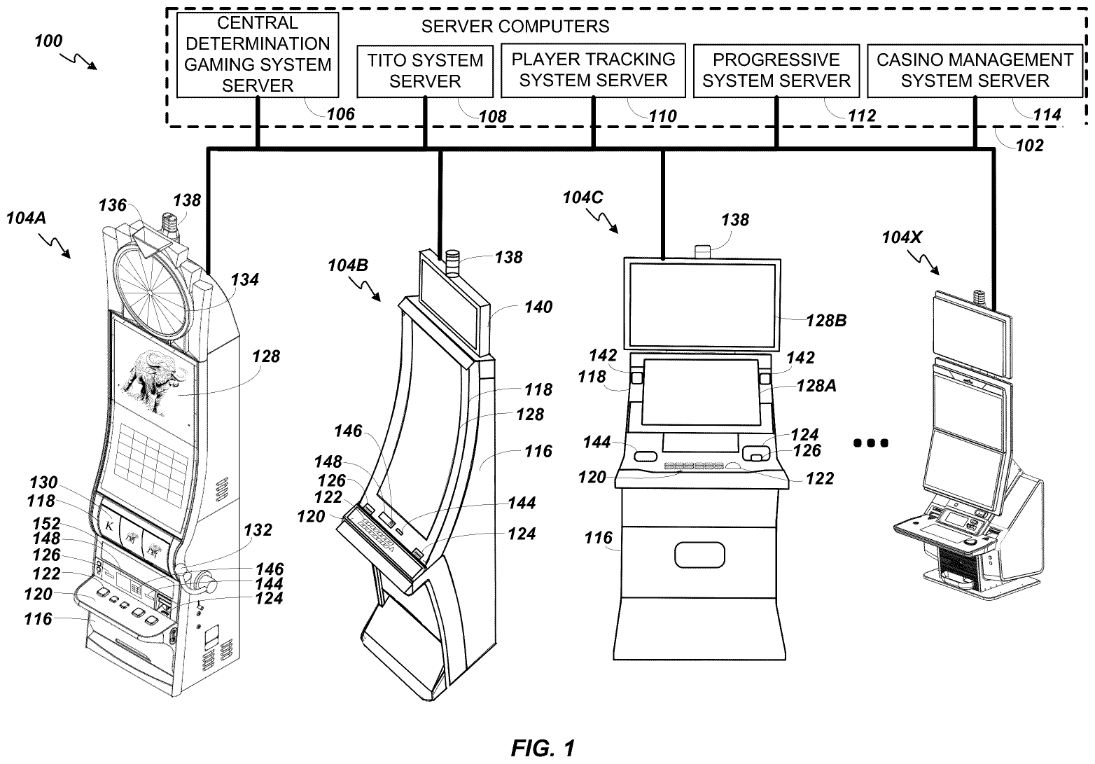

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

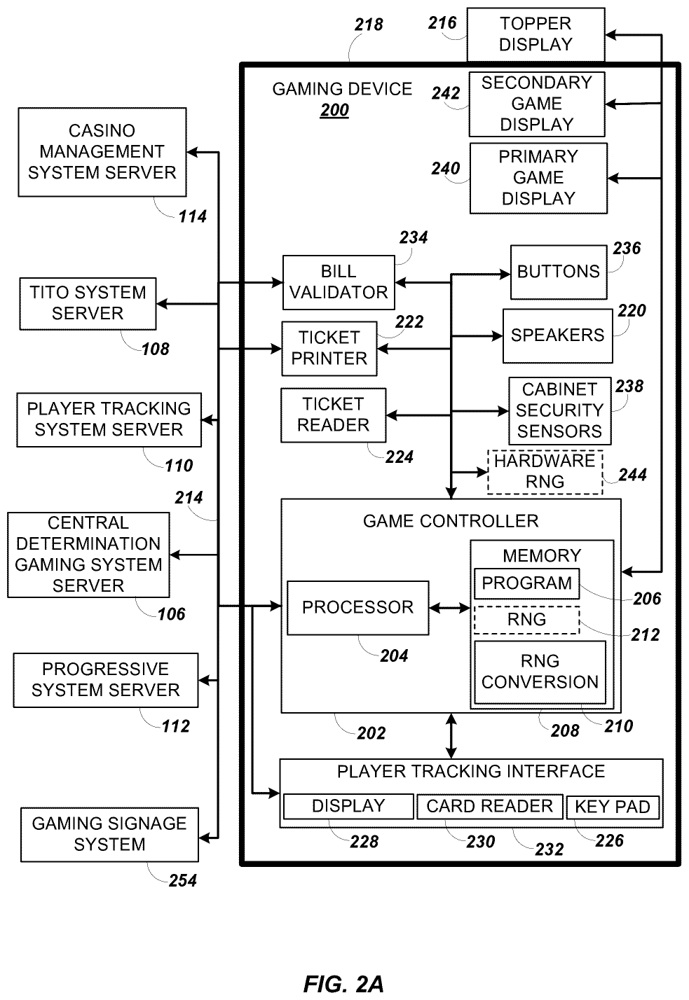

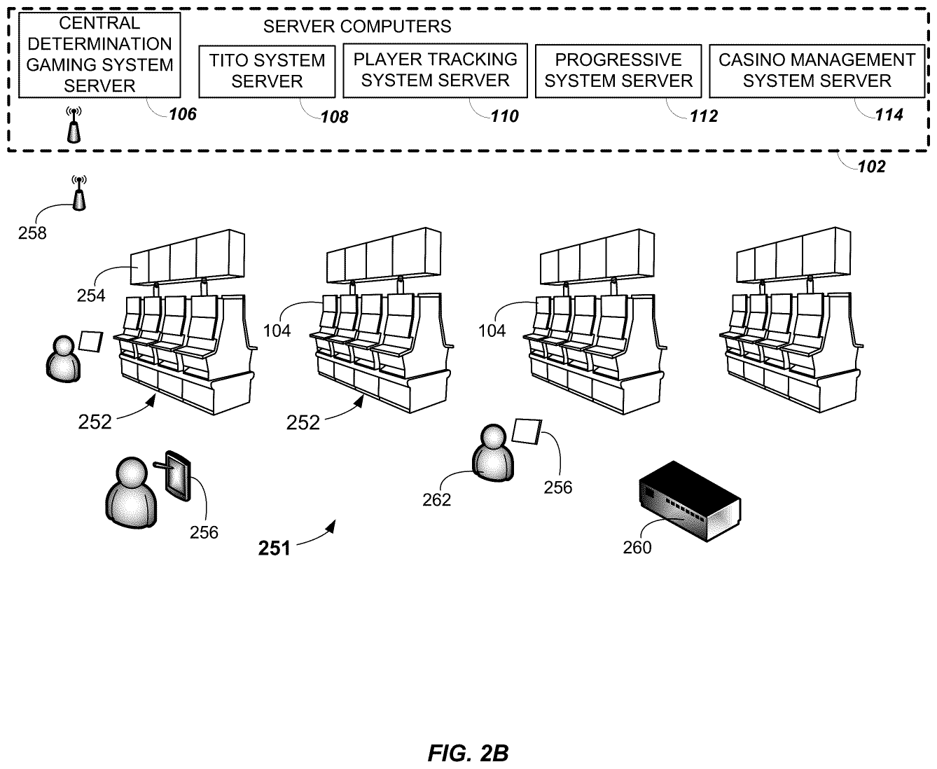

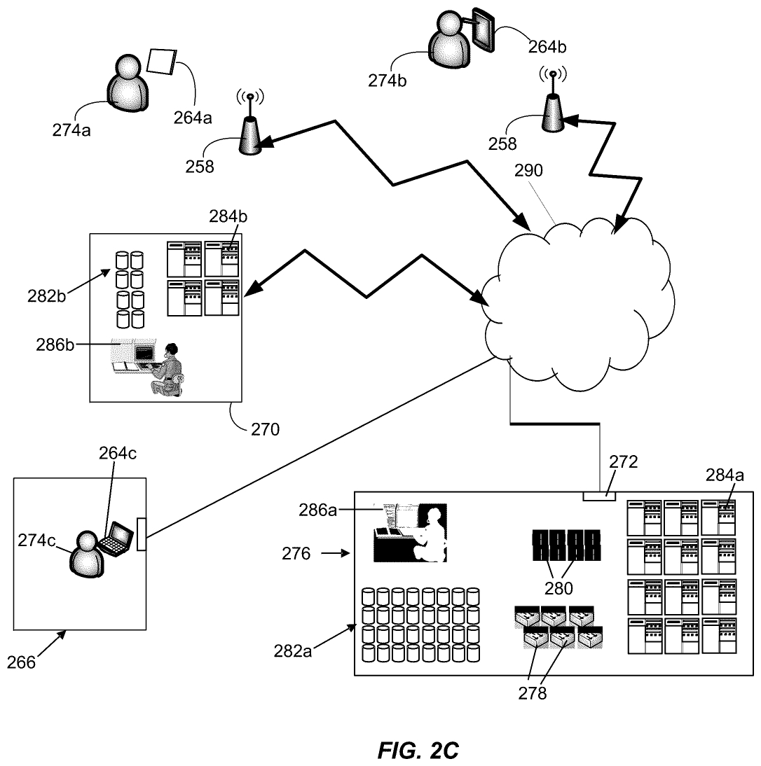

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, the main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for playing on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that does not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming authorities mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The player uses the credit balance to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game displays 240 and secondary game display 242. Other game and prize information may also be displayed.

For each game instance, a player may make selections, which may affect the play of the game. For example, the player may vary the total amount wagered by selecting the amount bet per line and the number of lines played. In many games, the player is asked to initiate or select options during the course of game play (such as spinning a wheel to begin a bonus round or selecting various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into game controller 202. The use and discussion of FIGS. 1 and 2 are examples to facilitate case of description and explanation.

FIG. 2B depicts a casino gaming environment according to one example. In this example, casino 251 includes banks 252 of EGMs 104. In this example, each bank 252 of EGMs 104 includes a corresponding gaming signage system 254 (also shown in FIG. 2A). According to this implementation, casino 251 also includes mobile gaming devices 256, which are also configured to present wagering games in this example. The mobile gaming devices 256 may, for example, include tablet devices, cellular phones, smart phones and/or other handheld devices. In this example, mobile gaming devices 256 are configured for communication with one or more other devices in the casino 251, including but not limited to one or more of the server computers 102, via wireless access points 258.

According to some examples, mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link.

In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

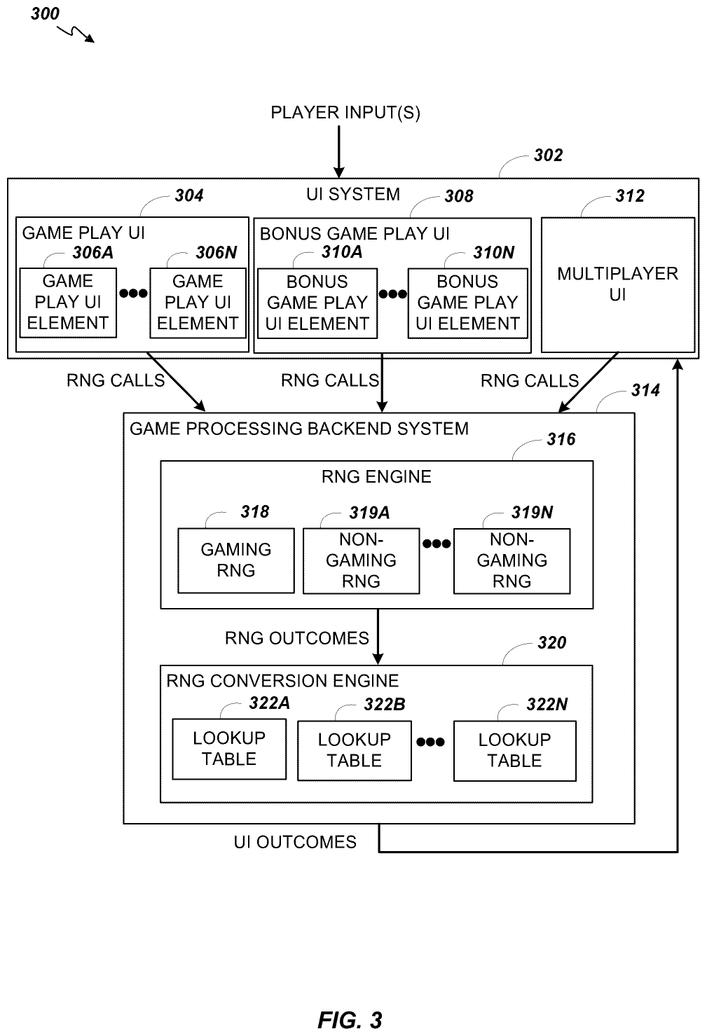

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Provided herein are new and novel seating systems and electronic gaming systems. It is desirable to provide unique, exciting, and immersive experiences for electronic gaming systems for individual players, multiple players, potential players, and onlookers. Various improvements to electronic gaming experiences may be made with seating systems that provide additional lighting, sound, video, and other sensory enhancements. This may include providing a seat, which may also be referred to herein as a bench or gaming bench, on which one or more persons may sit to play or watch game instances. The seat may be a part of a seating system that has multiple features like one or more displays, a kiosk, and features for receiving input from a user such as a button, a button deck with physical buttons, or a virtual button deck. In some instances, the seating system may be physically separate from the electronic gaming machine (EGM) and its one or more displays. In other instances, the seating system may have one or more displays of the EGM, such that the seating system is physically coupled to the one or more displays of the EGM.

In some implementations, the seat of a seating system may have a curved flexible display panel positioned on a side panel and/or armrest of the seating system. The curved flexible display panel is configured to display various materials, such as images, videos, game information, attractions, a portion of a game instance, or a combination thereof. In some instances, the seating system may have one or more side panels with curved surfaces and positioned thereon is the curved flexible display panel. The seating system may also have an armrest, and in some implementations, the curved flexible display panel is positioned on the armrest. Some implementations may have curved flexible displays on both the side panel and the armrest of the seat.

The seating systems provided herein may also have an operating console that has detachable and reconfigurable end pieces, and that is configured to rotate and, in some cases, translate along an axis. As provided herein, the operating console is configured to receive input from a player and, in some implementations, display information to the player on the seat. The operating console is also configured to communicate with a game controller of the EGM and thereby transmit the player input to the game controller and receive information from the game controller. In some implementations, the operating console is configured to move between orientations and/or locations to provide different playing configurations, such as a one-player configuration and a two-player configuration. In a one-player example configuration, one of the operating console's end pieces may have a button for receiving a player's input, and the operating console is positioned such that this button is positioned in a suitable location for single player gameplay, such as in the center of the seat. In a two-player example configuration, each of the operating console's end pieces may have a button, respectively, for receiving a player's input, and the operating console is positioned such that each player can reach their own respective button. For instance, the operating console may be positioned such that one button on a first end piece is closer to a first side of the seat, and the other button on the second end piece is closer to a second side of the seat. This configuration of the operating console provides both players the opportunity to press their own button and play a game on the EGM.

As provided above, the operating console may be reconfigured with different end pieces that may have different functionality or configurations. For example, each end piece may have a button for receiving a player's input. One of these end pieces may be removed and replaced with another end piece that may have a different button, the same button, or a different feature or function. Such reconfigurability provides numerous benefits. For instance, if a button or end piece becomes non-operable, then a new end piece with a new button can be positioned on the operating console without replacing or repairing the entire operating console or seating system. In another example, one end piece may be removed and replaced with an end piece having a different button that may have a different size, function, shape, orientation, or a combination thereof. For instance, one end piece may have a circular button, and it may be removed and replaced with a button of a different shape, such as a triangle or tri-lobe button.

In another instance, end pieces may have buttons at different orientations to account for rotation of the operating console. This may advantageously position the buttons at the same orientation with respect to the seat and player, while the operating console is at different orientations. For instance, a first end piece may have a button in a first orientation with respect to the end piece and operating console. A second end piece may have the same shaped button in a second, different orientation, with respect to the end piece and operating console, such as 90 degrees different than the first orientation. Although these two end pieces have buttons at different orientations with respect to the operating console, these two end pieces are configured to position the button in the same orientation with respect to the seat when the operating console has been rotated between positions. In this example, the operating console may have the first end piece and be in a first position with respect to the seat, which orients the button in a play orientation with respect to the seat. When the operating console is rotated to a second position, the first end piece may be replaced with the second end piece which has the button positioned in the second, different orientation with respect to the operating console, but at the same play orientation with respect to the seat. This advantageously positions the button in the same orientation with respect to a player despite rotation of the operating console. This example is further discussed and illustrated below.

In some implementations, an end piece of the operating console may have a feature other than a button, such as a display for providing information to a player on the seat. Similar to the orientation of the buttons described above, some end pieces may have the displays at different orientations with respect to the operating console. For example, a first end piece may have a display at a first orientation with respect to the first end piece and the operating console, and a second end piece may have the display at a second orientation with respect to the second end piece and the operating console. These two end pieces are configured to account for rotation of the operating console by having their displays positioned at different orientations with respect to the operating console. When the operating console is rotated between different positions, the displays on the first and second end pieces, respectively, may be in the same orientation with respect to the seat.

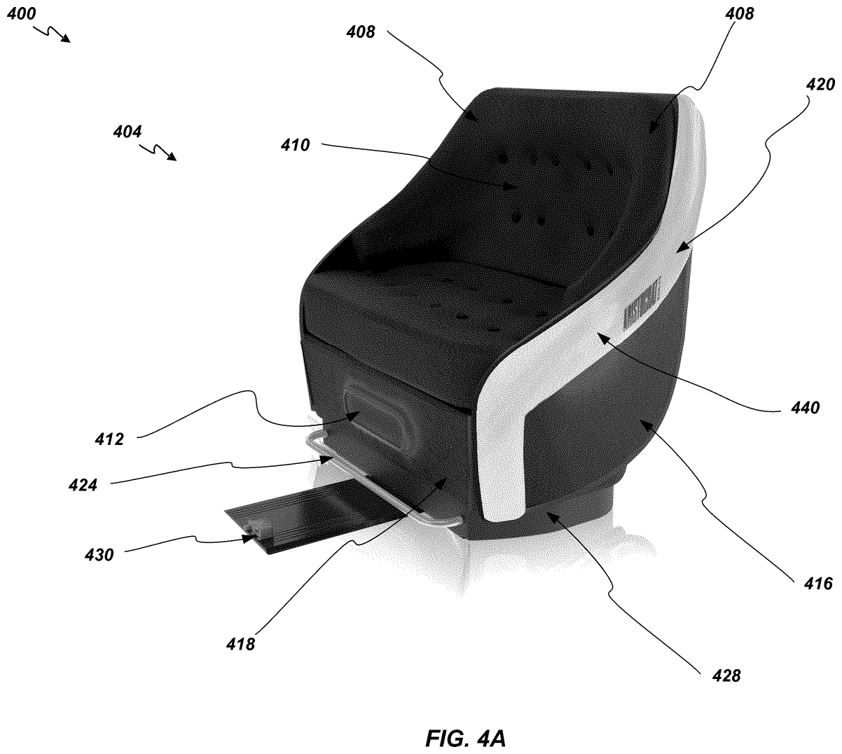

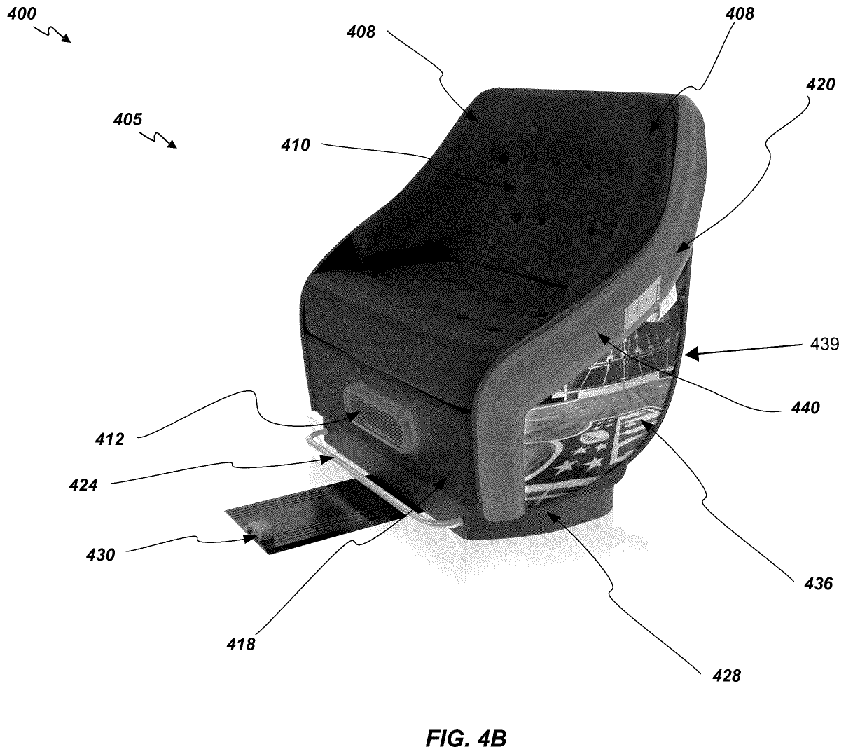

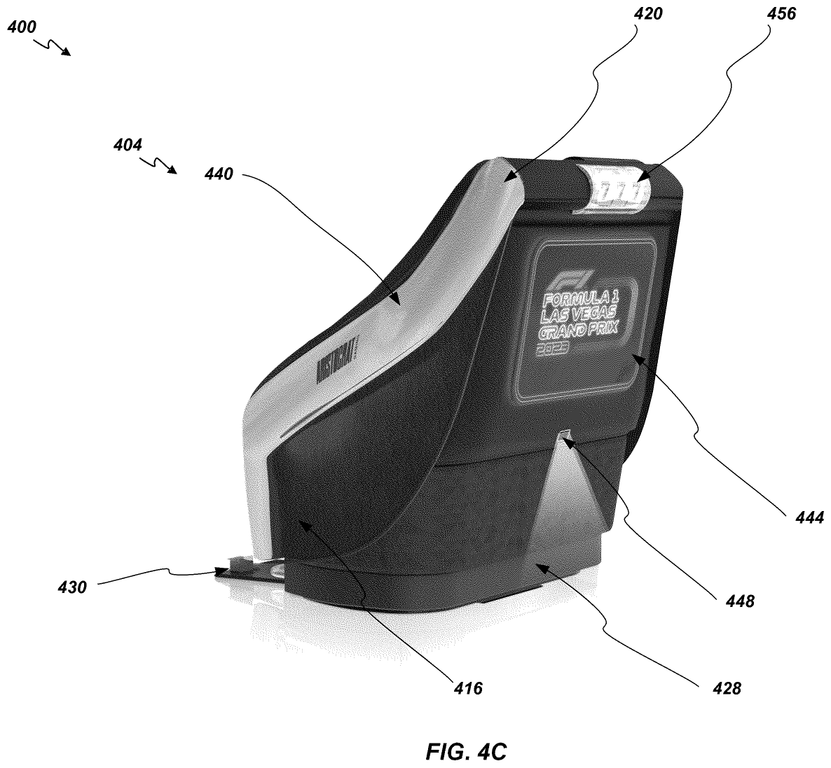

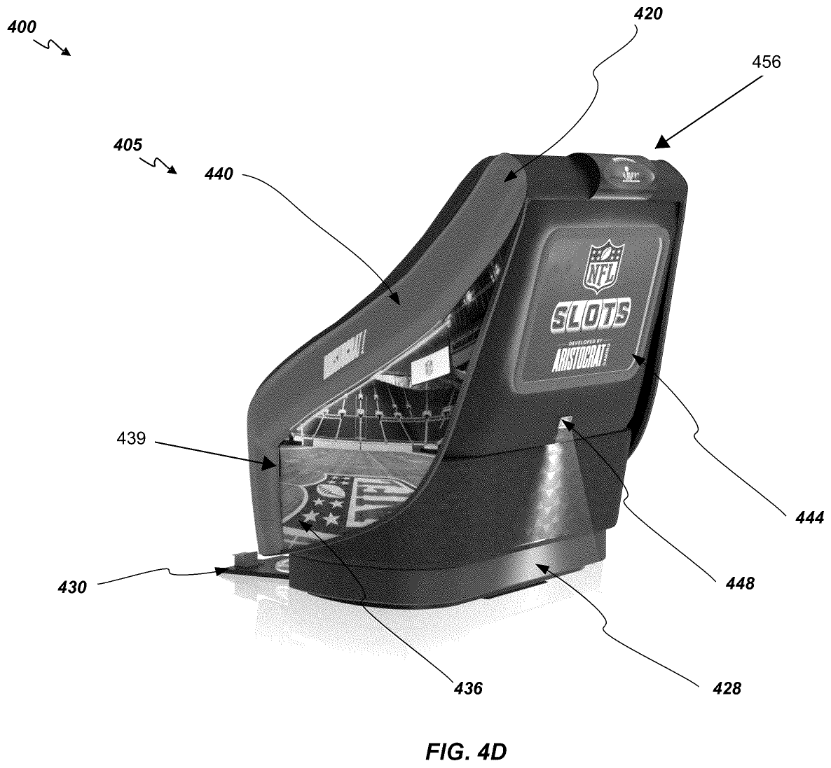

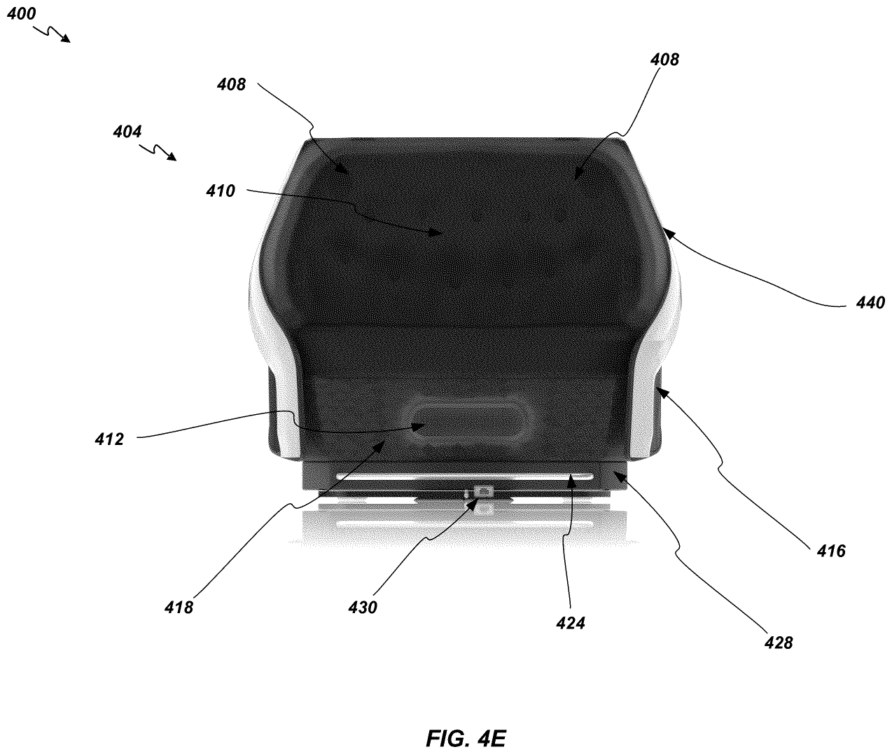

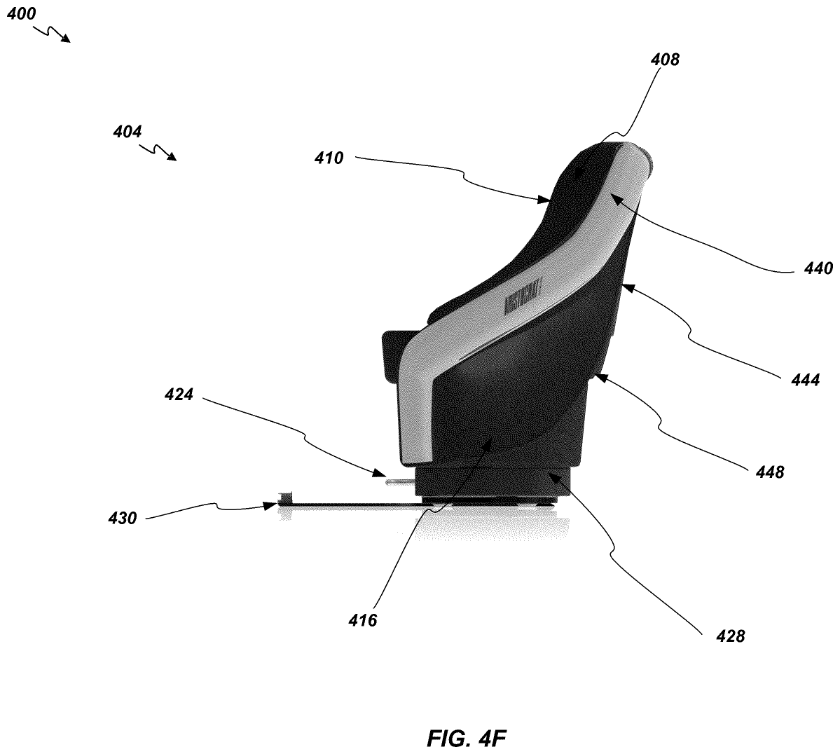

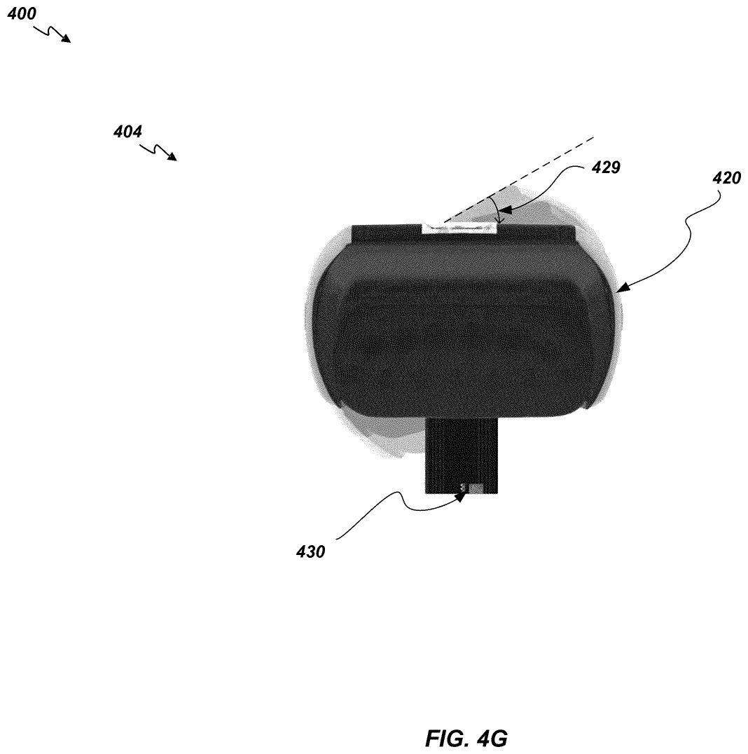

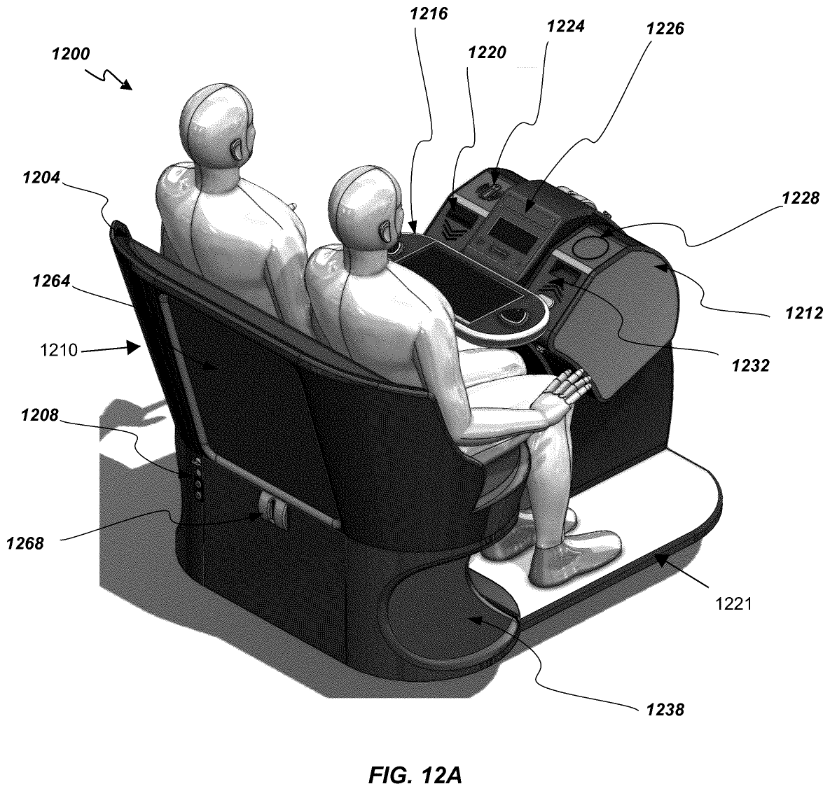

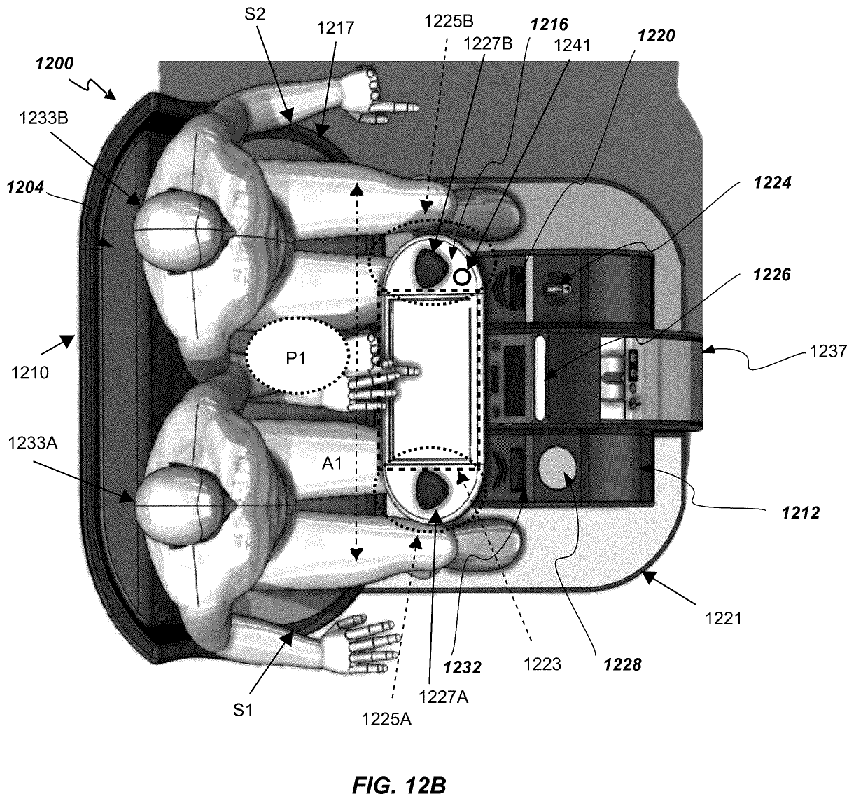

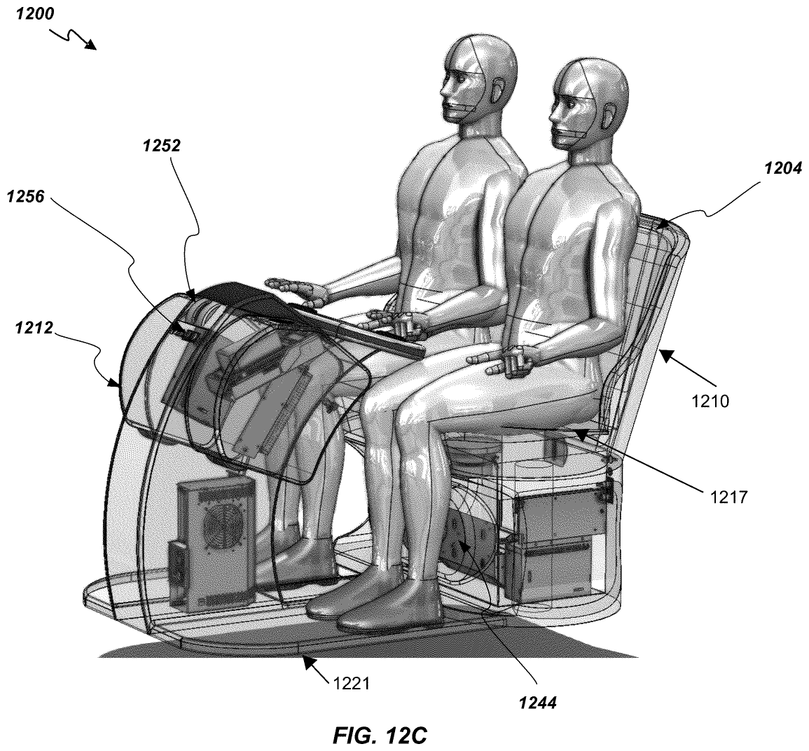

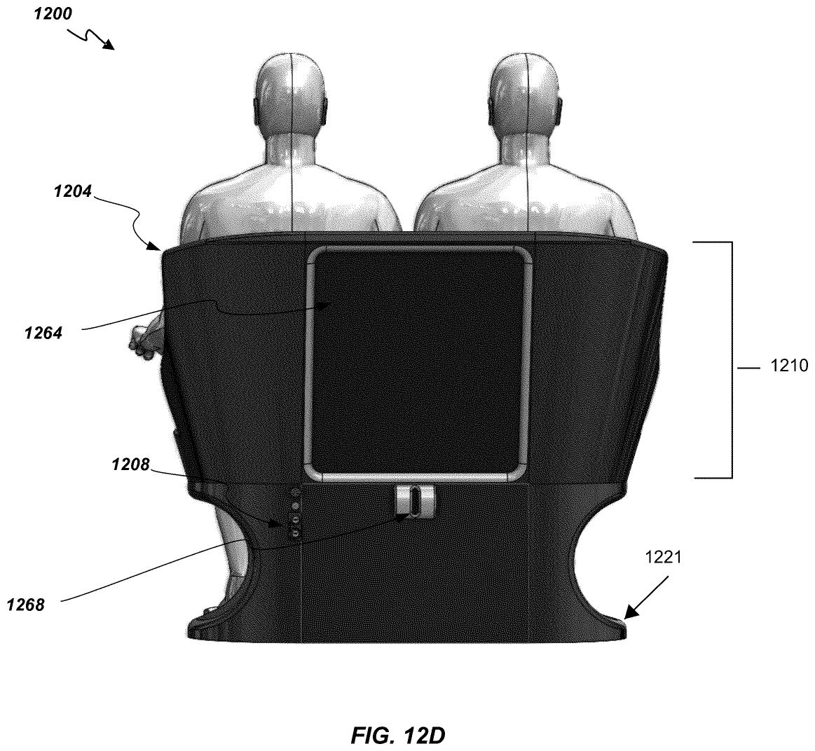

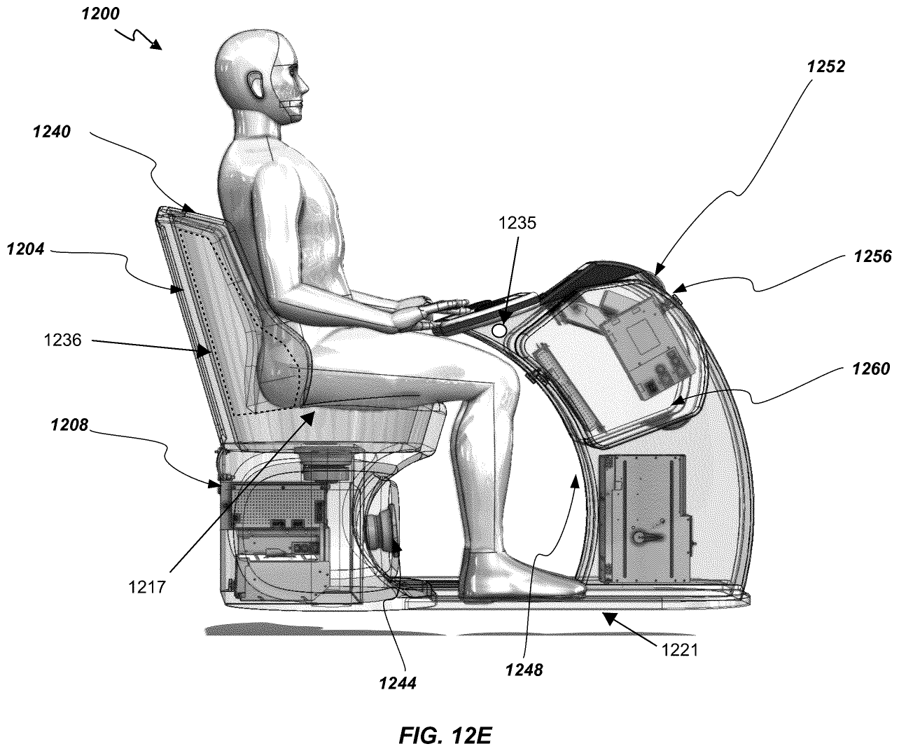

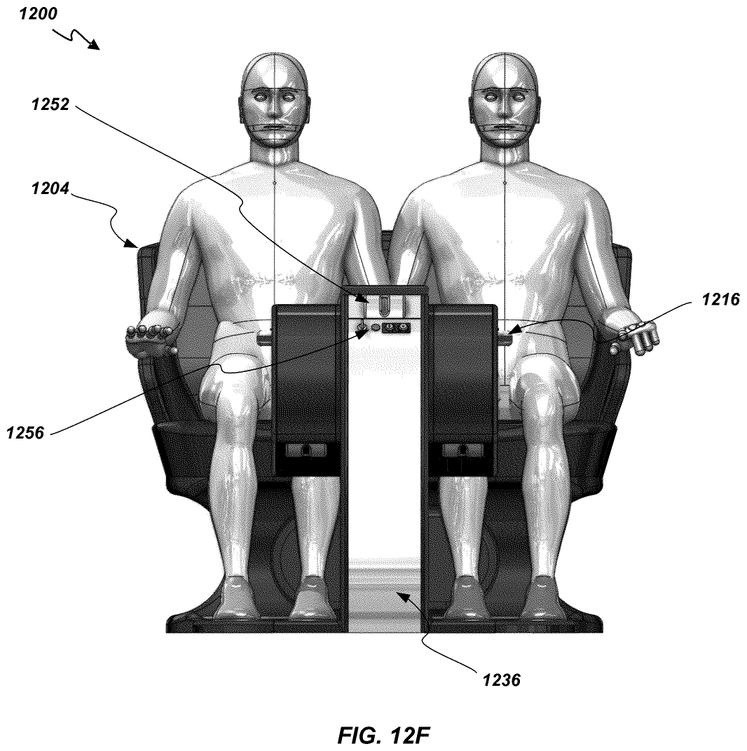

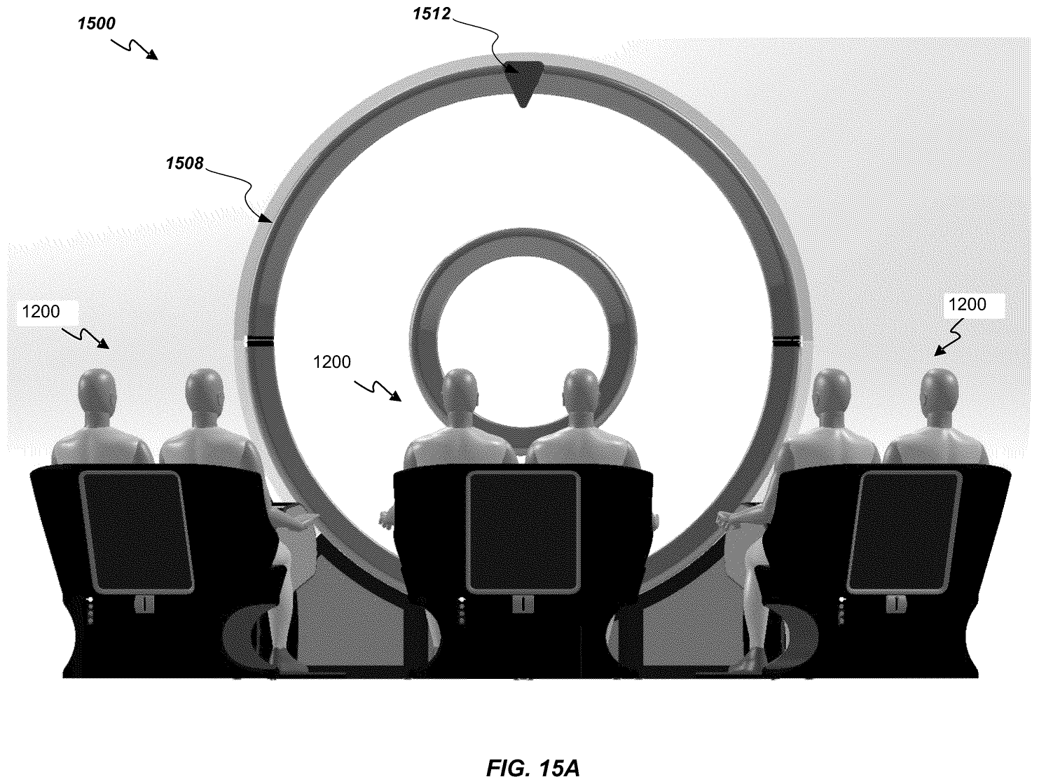

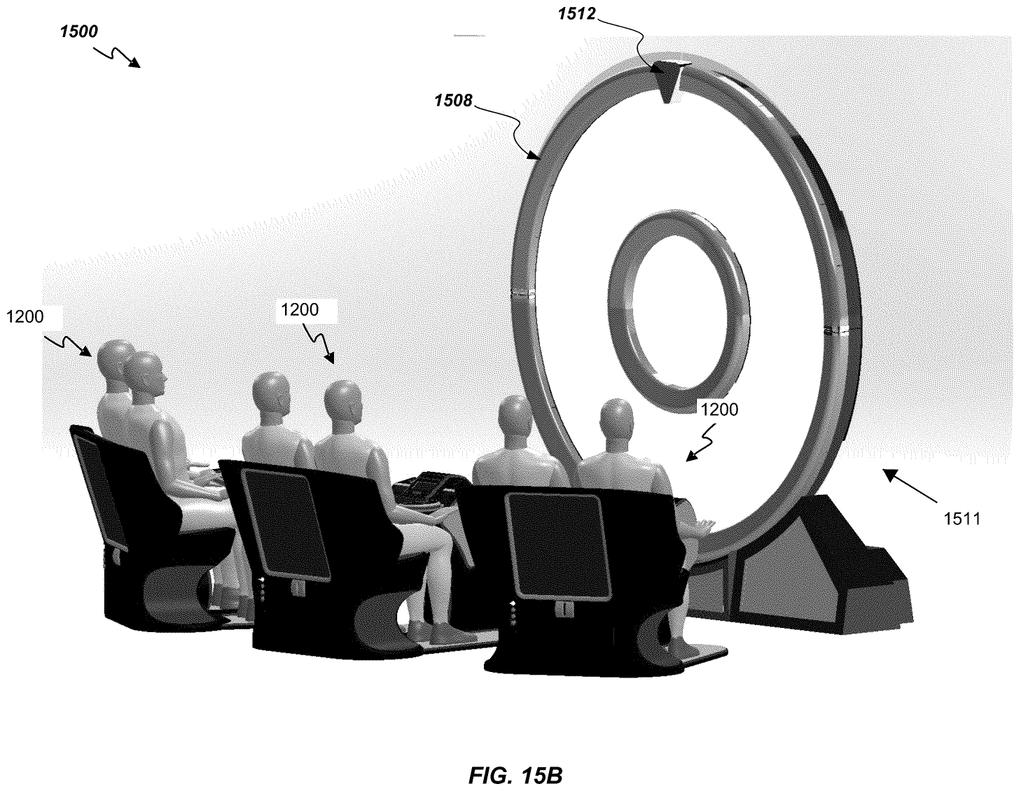

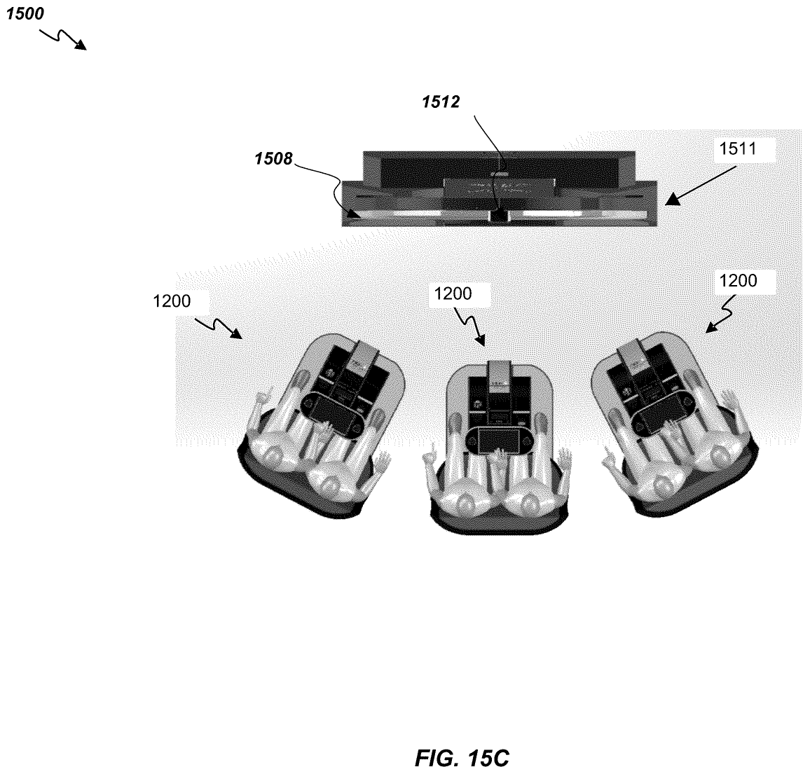

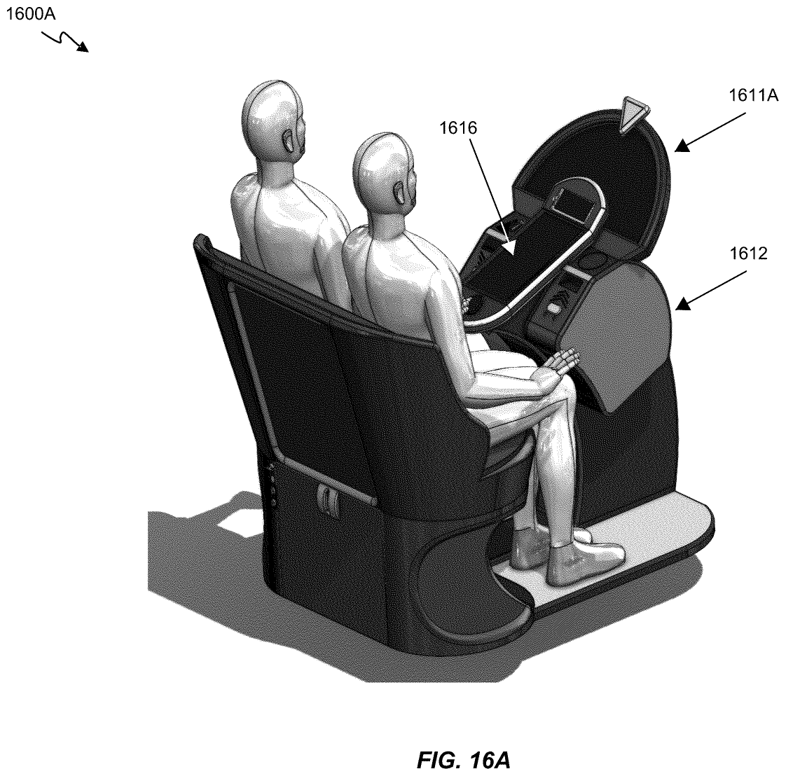

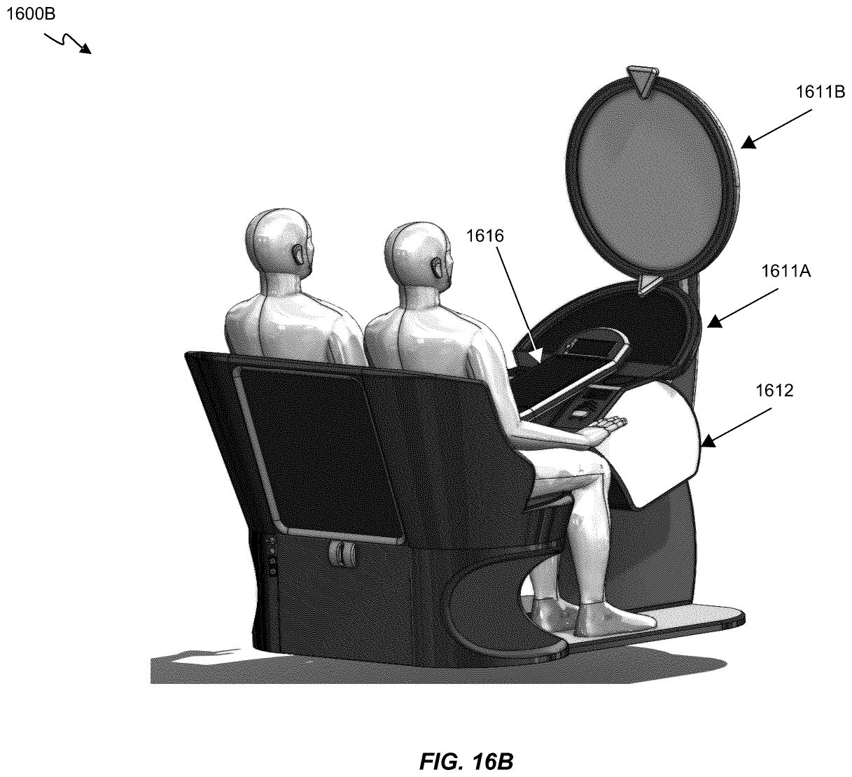

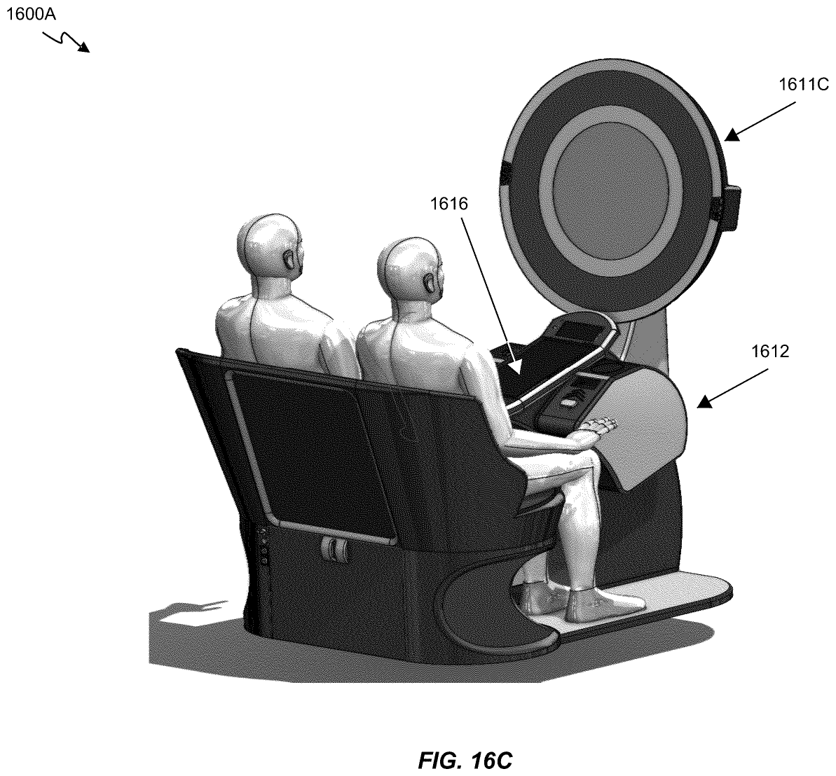

Various implementations of seating systems will now be discussed. Provided herein are numerous examples of seating systems, and the discussion will begin with an example seating system 1200 and some of its features shown in FIGS. 12A-12F, 13, 14, and 17A-C. Additional seating systems are illustrated in FIGS. 4A-11B as well as FIGS. 15A-16C, and discussion of these systems are farther below. As used herein, both the phrases a “seating system” and an “electronic gaming machine,” are used herein and for purposes of this disclosure, both these phrases may be used interchangeably.

Turning now to FIGS. 12A-12F, these Figures illustrate different views of the example seating system 1200. The last two numbers of each reference numeral used in FIGS. 12A-12F refer to the same features with reference numerals having the same last two numbers in other figures. The seating system 1200 here has a seat 1204, which may also be referred to herein as a “bench” or “gaming bench.” The seat 1204 has a seating surface 1217 (identified in FIGS. 12B, 12C, and 12E) on which one or more players may sit. The seat 1204 also has a backrest 1210 (identified in FIGS. 12A-12D) which may be configured to support the back of a player sitting on the seat 1204.

The seating system 1200 also has a kiosk 1212 that is coupled to the seat 1204. This coupling may be direct or indirect. In FIGS. 12A-12F, the kiosk 1212 is depicted as indirectly coupled to the seat 1204 via a base 1221 of the seating system 1200. In these illustrations, the kiosk 1212 is directly coupled to the base 1221 and the seat 1204 is directly coupled to the base 1221. In some implementations, the kiosk 1212 has various features. For example, the kiosk 1212 may have a ticket printer 1220 (similar to the ticket printer 222 of FIG. 2), a wireless charging device 1224, a player tracking device 1226 (similar to the player tracking interface 232 of FIG. 2), a cup holder 1228, a bill validator 1232 (similar to the bill validator 124 of FIG. 1), a door access 1237, or a combination thereof. FIG. 12A also shows that the seat 1204 includes a bottom panel 1238 that may include a light panel with an etched pattern.

The seating systems are configured to be communicatively coupled with an electronic gaming machine, such as any EGM provided herein. These EGMs, which may also be considered electronic gaming systems, may have one or more displays and one or more game controllers, like described herein. The EGMs also have features configured to receive input from a player and provide this input to the EGM. These input receiving features may be located on the operating console of the seating system, as provided herein, and may include physical and/or virtual buttons.

For the seating system 1200 illustrated in FIGS. 12A-12F, it has an operating console 1216 that is configured to receive input from a user or player, and that is configured to be reconfigurable and rotatable. As illustrated in FIG. 12B, the operating console 1216 may have a button deck 1223 which is encompassed by a dashed rectangle and this button deck 1223 may have a rectangular shape. The button deck 1223 may have a display panel configured to provide a virtual button deck, may have one or more physical buttons, or both. The button deck 1223 is configured to receive player input and in some cases, display information related to a game on the EGM. The operating console 1216 also has a first end piece 1225A detachably coupled at one end of the operating console 1216 and a second end piece 1225B detachably coupled at an opposite end of the operating console 1216, both of which are encircled with dashed ellipses.

Each end piece 1225A and 1225B may be configured to receive player input, provide information, or both. For example, in FIG. 12B, each end piece 1225A and 1225B has a button 1227A and 1227B, respectively, configured to receive input from a player. The button may be a physical button that is configured to move (e.g., a pressable button or a “smash” button), as well as a virtual button. In some implementations, the button may be a physical button that also has a display provided therein which may provide various information to a player, such as game related information like a wager amount or prompts (e.g., “GO!”, “START”, “PLAY”, “WIN!”). In some implementations, like described below, an end piece may have a display configured to display information, such as a player tracking information.

The operating console 1216 is configured such that its end pieces 1225A and 1225B are detachably coupled to the button deck 1223. These end pieces may be detached (i.e., removed or uncoupled) from the operating console, and other end pieces may be detachably coupled to the operating console. The physical coupling between the operating console 1216 and the end pieces may include various connection features, such as clips, bolts, screws, or the like. This may include an end piece sliding onto the operating console 1216 and held in place with screws. There may also be electrical and/or data coupling between the operating console and the end pieces, such as by USB-A, USB-C, HDMI, Ethernet (RJ45), DisplayPort, VGA, DVI, Mini DisplayPort, serial connectors like RS-232 (DB-9), or the like. In some instances the operating console 1216 will have sensors configured to detect an end piece being removed. One example is a reed sensor with a magnet and a reed switch that together are configured to create a magnetic circuit, and when one component is moved relative to the other, the circuit is broken which may indicate an end piece has been removed.

In some implementations, a system provided herein may have one or more USB ports and/or Micro USB ports configured to provide charging of, and/or communication with, a device, such as a player's portable electronic device and/or a gaming device accessory, such as a remote button like a remote spin button. The communication between the one or more USB ports or Micro USB ports and the device may be through a wired or wireless communications interface. In some instances, the system may have a wireless communications interface configured to receive and transmit information between a controller of the system and the device. In some instances, the USB ports or Micro USB ports may provide wireless communications via a wireless antenna connected thereto. The one or more USB ports or Micro USB ports may be positioned on various aspects of the system, such as on an end piece, on the operating console 1216, on the button deck 1223, on the kiosk 1212, on the seat 1204, on an armrest, on the bottom panel 1238, or a combination thereof. As illustrated in FIG. 12B, a USB port 1241 is provided on the second end piece 1225B.

The operating console 1216 is also configured to be rotated into different orientations and usable in any of the orientations. For instance, the operating console is configured to be rotated between a first orientation and a second orientation 90 degrees apart from the first orientation. In some instances, the operating console 1216 has a rotatable mount, like a swivel mount, connected to the kiosk 1212, as represented by a circle 1235 in FIG. 12E. The operating console 1216 may be configured to be rotated by one of the players without the use of any tool. A retention feature, like a latch or switch, may retain the operating console 1216 in the first or second orientation, and the latch or switch may be manually actuated by the player in order to rotate the operating console. In some implementations, a mechanical rotation mechanism may automatically rotate the operating console 1216.

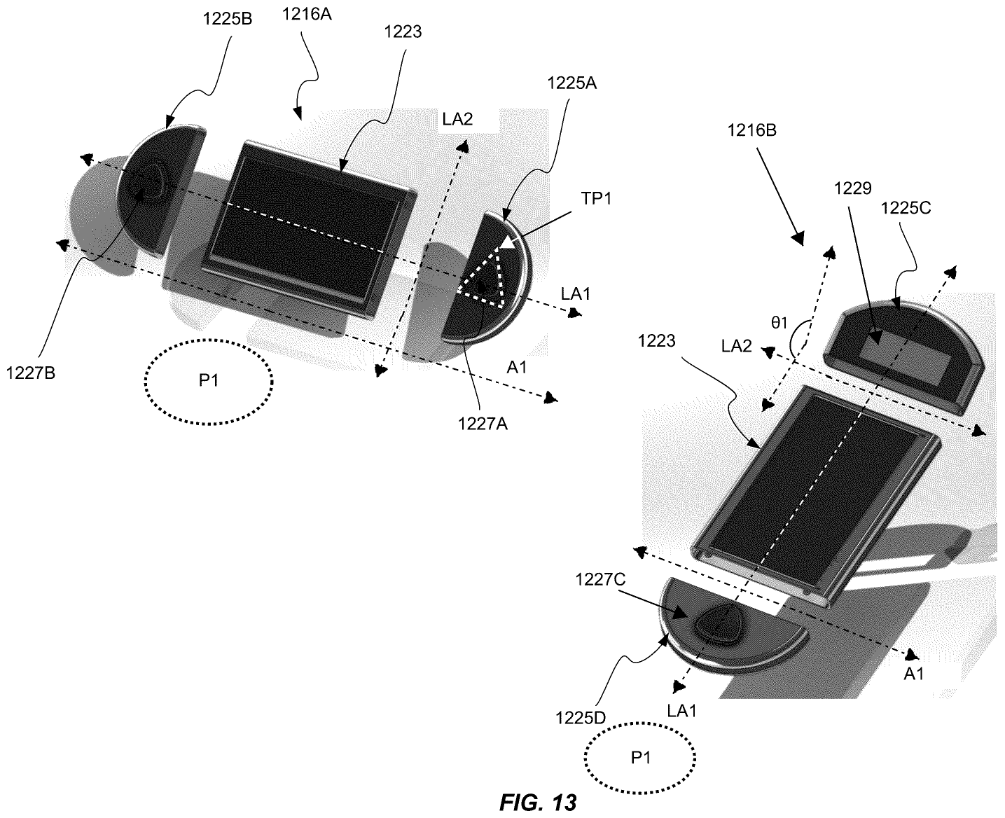

Features of the operating console are further illustrated in FIG. 13 which depicts the operating console of the electronic gaming system in FIG. 12A. Here in FIG. 13, two example configurations of the operating console 1216 of system 1200 are provided. In the lefthand portion of FIG. 13 is operating console 1216A in a first configuration. In this first configuration, operating console 1216A is in a first orientation and has two end pieces 1225A and 1225B. Each end piece 1225A and 1225B has a button 1227A and 1227B, respectively. The first orientation of the operating console 1216A may be in reference to a first axis A1 of the seating system and/or a position P1 of a player on the seat (the first axis A1 and position P1 are also shown in FIG. 12B). In the first orientation, a longitudinal axis LA1 of the operating console 1216A is oriented parallel to the first axis A1 and a lateral axis LA2 of the operating console 1216A is oriented perpendicular to the first axis A1. In some instances, this first orientation may be considered a landscape or horizontal orientation.

As illustrated in FIG. 13, the end pieces 1225A-1225D of the operating console are configured to be uncoupled (i.e., detached) and coupled (i.e., attached) to the button deck 1223. This detachability may provide numerous advantages, such as the use of buttons, displays, or other features at different orientations with respect to the button deck 1223 in order to provide such features in a desired orientation with respect to a player on the seat. For example, operating console 1216B in the righthand portion of FIG. 13 is in a different orientation than operating console 1216A, and operating console 1216B has two different end pieces 1225C and 1225D. In this different orientation, or second orientation, the operating console 1216B has been rotated 90 degrees with respect to the first orientation of operating console 1216A. As can be seen for operating console 1216B, the longitudinal axis LA1 is oriented perpendicular to the first axis A1 and the lateral axis LA2 is oriented parallel to the first axis A1. In some instances, this second orientation may be considered a portrait or vertical orientation.

For operating console 1216B, its end pieces 1225C and 1225D have been attached to the button deck 1223 and they have replaced end pieces 1225A and 1225B. The end piece 1225C has a display 1229 that is configured to display information to a player, such as information about the game being played on the EGM or information related to the player's account. The other end piece 1225D has a button 1227C that has the same shape as buttons 1227A and 1227B, but this button has a different orientation with respect to the end piece and the button deck than buttons 1227A and 1227B. For a player in the position P1 relative to operating console 1216A and operating console 1216B, the buttons 1227A, 1227B, and 1227C are positioned in the same orientation with respect to this position P1 despite rotation of the operating consoles 1216A and 1216B.

To provide the rotatable operating console with buttons in the same orientation with respect to a player, different end pieces may be used that position the buttons in different orientations with respect to the operating console. As illustrated in FIG. 13, the operating console 1216 has different end pieces with buttons in different orientations, and these different orientations are configured to position the buttons in the same orientation with respect to the seat or position P1. More specifically, in the lefthand side of FIG. 13, the first and second buttons 1227A and 1227B of end pieces 1225A and 1225B, respectively, are positioned in a first button orientation with respect to the button deck 1223 and in a second button orientation with respect to the first axis A1 and position P1. To further illustrate this orientation, a representative dashed triangular outline of button 1227A is depicted on end piece 1225A. In this configuration, one triangular point TP1 of the button is farther from the first axis A1 than the other two points of the triangle. This one triangular point TP1 is also facing towards the curved outer surface of the end piece 1225A. In some instances, like shown, the other two triangular points may be arranged along an axis parallel to the longitudinal axis LA1.

When the operating console is rotated from the first orientation (e.g., the lefthand side of FIG. 13) to the second orientation (e.g., the righthand side of FIG. 13), the operating console 1216B has another end piece 1225D with button 1227C. In some implementations, button 1227C is the same as button 1227A or 1227B, although button 1227C is positioned in a different orientation than buttons 1227A and 1227B with respect to the end piece and operating console 1216B. As can be seen, the button 1227C has been rotated with respect to the end piece 1225D and the button deck 1223. In comparison to buttons 1227A and 1227B, the button 1227C has been rotated 90 degrees with respect to the end piece 1225D and button deck 1223. The triangular point TP1 of button 1227C is facing a linear section of the end piece 1225D and facing the button deck 1223. Further, the other two triangular points are arranged along an axis parallel to the lateral axis LA2 of the operating console 1216B. With respect to the first axis A1 and the position P1, the button 1227C is positioned in the same orientation as buttons 1227A and 1227B.

In some implementations, an end piece may be oriented at a non-parallel angle with respect to the button deck. Referring back to the end piece 1225C with the display 1229, this end piece is oriented at a non-parallel angle θ1 with respect to the button deck 1223. This angle may orient the display 1229 so it is more visible to a player in the seat than if the display 1229 was parallel to the button deck 1223. In some implementations, this angle θ1 may be considered obtuse such that it is larger than 90 degrees and smaller than 180 degrees, such as about 120 degrees, about 135 degrees, or about 145 degrees, for example.

The ability to uncouple and couple the end pieces provides numerous advantages. For example, when an end piece needs repair or replacement (e.g., the button stops working or breaks), a new end piece can be positioned on the operating console 1216 without repairing the entire operating console 1216 or seating system. In another example, end pieces with different buttons, displays, or other functionality may be provided on the operating console 1216 so that it may be used with multiple EGMs and games without redesigning or building a new seating system for each EGM or game, and thereby reducing costs and time. In yet another example, as described herein, the buttons, displays, or other features of the end pieces can be oriented in the desired positions despite rotation or other movement of the operating console.

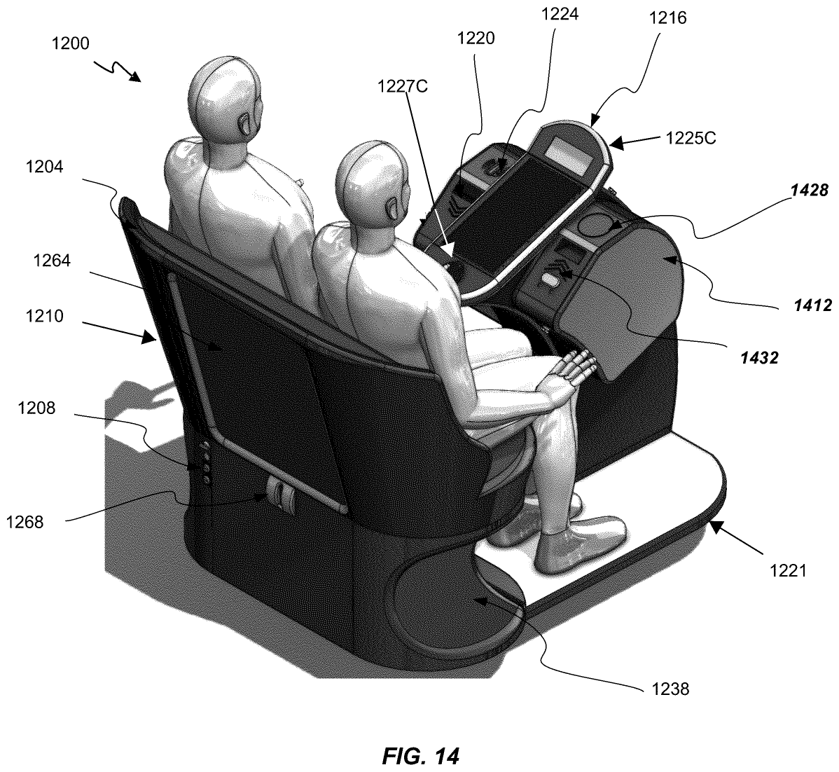

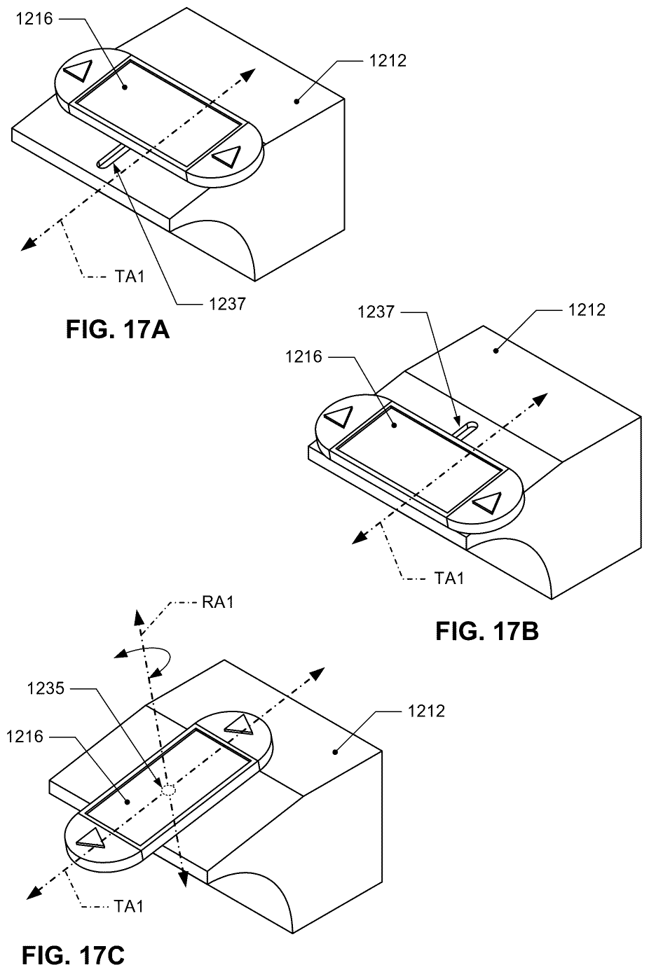

The rotation of the operating console is also illustrated in FIGS. 14 and 17A-17C. FIG. 14 depicts seating system 1200 in another configuration. In some instances, this other configuration may be the same as that of operating console 1216B of FIG. 13 described above. Here in FIG. 14, the operating console 1216 has been rotated by 90 degrees as compared to that of FIGS. 12A-12E, such as into the vertical or portrait orientation. The two end pieces 1225C and 1225D of the operating console 1216 of FIG. 14 are also different than the two end pieces 1225A and 1225B of the operating console 1216 of FIGS. 12A-12F. Like in FIG. 13, the two end pieces 1225A and 1225B have been decoupled and replaced with the end piece 1225C having the display and end piece 1225D having the button 1227A in a different orientation, with respect to the button deck 1223, than buttons 1227A and 1227B. Although FIGS. 12A-14 show the operating console being rotated between two orientations 90 degrees apart, the angular difference may be other angles in other implementations. For instance, the angular difference between the two orientations may be 90 degrees or within about +/−10 degrees from 90 degrees.

Configuring the operating console 1216 in multiple orientations provides for additional gameplay flexibility. For example, as illustrated in FIG. 12B, the operating console 1216 is in a first orientation configured to provide for two-player gameplay. This first orientation may be that of the lefthand side of FIG. 13. Here in FIG. 12B, the first button 1227A is closer to one side S1 of the seat 1204 and the second button 1227B is closer to the other side S2 of the seat. As further illustrated, one button 1227A is provided adjacent or closer to one player 1233A and the other button 1227B is provided adjacent or closer to the other player 1233B. This configuration of the seating system 1200 and operating console 1216 provides each player with their own button for playing a game. Positioning the operating console in a different configuration, such as that illustrated in the righthand side of FIG. 13, and in FIG. 14, may provide for other gameplay functionality. In FIG. 14, the operating console 1216 is positioned in the portrait orientation and this configuration may provide different or similar game play functionality than in FIGS. 12A-12F. For example, in FIG. 14 a single button 1227A is provided adjacent to the seat and may be the sole button for gameplay which may be used by one or both players on the seat 1204. Additional excitement or gameplay may be had by providing both players access to only one gameplay button.

In some implementations, the operating console may also be configured to translate, or move, along an axis. This translation movement may be relative to the kiosk 1212, the seat 1204, or both. The operating console translation is illustrated in FIGS. 17A-17C which depict off-angle views of the kiosk and the operating console in various configurations. Here, the kiosk 1212 and operating console 1216 are representationally depicted, along with a translation axis TAI. The kiosk 1212 and operating console 1216 in FIGS. 17A-17C may be considered any of the kiosks and operating consoles provided herein, such as those illustrated in FIGS. 12A-14.

The operating console 1216 is configured to be moved to one or more positions along the translation axis TAI. This movement may be by a player, a worker, a mechanical system (e.g., having a motor and a lead screw or linear translation screw), or a combination thereof. For example, the kiosk 1212 may have a slot or groove 1237 in which a connection feature of the operating console 1216 moves. The connection feature may be a connection to a linear translation screw, linear bearing, rail, or the like. In some instances, a spring friction or zero gravity display mechanism may be used. This can include a slotted groove along the translation axis TAI and a T-shaped bearing fitted into the slot of the slotted groove and attached to the operating console 1216. One or more springs are provided between the T-shaped bearing and the slotted groove to apply a spring force against both components. This spring force causes the T-shaped bearing to contact the slotted groove and to create a friction force between surfaces of the T-shaped bearing and the slotted groove to prevent relative motion between these components. The T-shaped bearing is configured to be movable, such as by a player, by pushing the operating console 1216 and T-shaped bearing relatively closer to the slotted groove which exerts a force opposite the spring force and releases the frictional force and allows the T-shaped bearing to be moved within and along the slotted groove. When this pushing is released, the spring force again causes the T-shaped bearing to contact the slotted groove and to create the friction force to prevent relative motion between the T-shaped bearing and the slotted groove.

In another example, a linear bearing may be connected to the operating console, provided in or on a guide rail positioned along the translation axis TAI, and configured to be clamped to the guide rail by a clamping mechanism. Actuation of a trigger or latch is configured to release the clamping mechanism and provide for movement of the linear bearing along the guide rail and release or further actuation of the trigger or latch may reengage the clamping mechanism and prevent further movement of the linear bearing. In yet another example, the motor and lead screw may be used and actuated to move the operating console 1216 based on input received from a player or other person, such as through a button on the operating console 1216.

Further, in some implementations, the translation axis TAI may be linear like illustrated in FIGS. 17A-17C, and the resulting translation by the operating console may also be linear. In some other implementations, the translation axis TAI may be nonlinear, e.g., curved, such that is has one or more nonlinear sections, or one or more nonlinear sections and one or more linear sections. The resulting translation by the operating console with respect to the kiosk may be nonlinear, or partially linear and partially nonlinear. Even with a nonlinear translation axis, this axis may still be configured to provide linear translation of the operating console with respect to the seat. For example, the operating console is configured to translate linearly towards and away from the seat.

Referring first to FIG. 17A, the operating console 1216 is in a first position, relative to the kiosk 1212, along the translation axis TAI. In FIG. 17B, the operating console 1216 is in a second position along the translation axis TAI that is different than the first position. The second position of FIG. 17B may be considered closer to the seat than the first position.

The operating console may be configured to both rotate, e.g., like in FIGS. 12A and 14, and translate, e.g., like in FIGS. 17A and 17B. To illustrate this movement, FIG. 17C further illustrates that the operating console 1216 may be rotated about a rotation axis RAI and translated along the translation axis TAI. The rotatable mount 1235, which is configured to provide the rotational movement of the operating console, is also representationally shown with a dashed circle 1235 here in FIG. 17C. The operating console 1216 may be configured to rotate about the rotation axis RAI at any point along the translation axis TAI.

Similar to above, translating the operating console to multiple positions provides for additional gameplay flexibility, as well as adaptive positioning for players. For example, a player can move the operating console to a comfortable distance away from the player, and the player can move the operating console farther away from the seat to provide clearance for the player's movement into and out of the seat. Additionally, this translation movement may assist with configuring the seating system into one-player or two-player configurations. For example, it may be desirable to position the operating console at the second position of FIG. 17B and the first orientation in FIGS. 17B and 12A-12F, such as for some two-player games.

It may also be desirable to rotate the operating console to the second orientation of FIG. 14 for other gameplay or games. Given the size of the seating system and its components, it may be advantageous to move the operating console closer or farther from the seat to accommodate the second orientation and rotation to the second orientation. For instance, the operating console may be too close to the seat in the second orientation for a player to sit comfortably. Translating the operating console farther from the seat in this second orientation may provide for additional space and clearance for a player on the seat. In some instances, this movability of the operating console may provide players the option to configure the seating system for one-player or two-player gaming without the use of tools and at any time desired by the players. A player may push, pull, and/or rotate the operating console, without using a tool, between both orientations and positions with respect to the seat.

Some other aspects of the seating systems provided herein will now be discussed, such as flexible displays positioned on one or more areas of the seat. Each seating system has a seat with a seating surface and a backrest. The seating surface is configured to support, and be in contact with, a player's buttocks, and the backrest is configured to support, and be in contact with, the player's back while sitting on the seating surface. In some instances, the seat may have a side panel adjacent to the seating surface and backrest, an armrest also adjacent to the seating surface and backrest, or both. In some instances, the armrest may be a part of the side panel. As provided herein, some implementations of the seating systems may have one or more flexible displays configured to display various images and videos, and positioned on a seat side panel, an armrest, or both. The side panel and/or armrest may have one or more curved surfaces, and the one or more flexible displays may be curved and positioned on these one or more curved surfaces. In some implementations, the flexible displays are configured to display game information, attractions, a portion of a game instance, images, videos, or a combination thereof. These seating systems may also have any of the features provided herein, such as the kiosk 1212 and operating console 1216 described above. The flexible, curved displays provided herein may be flexible liquid crystal displays (LCD), flexible electrophoretic displays (EPD), flexible organic light emitting diode (OLED) displays, rollable TFT-driven OLED display boards, electronic paper displays, and the like.

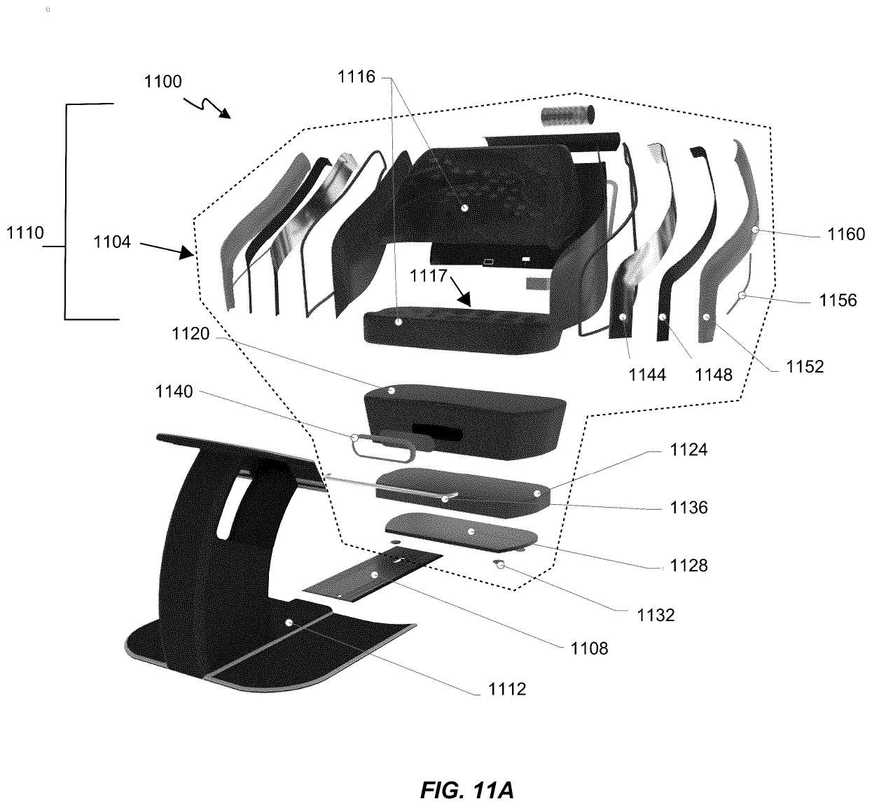

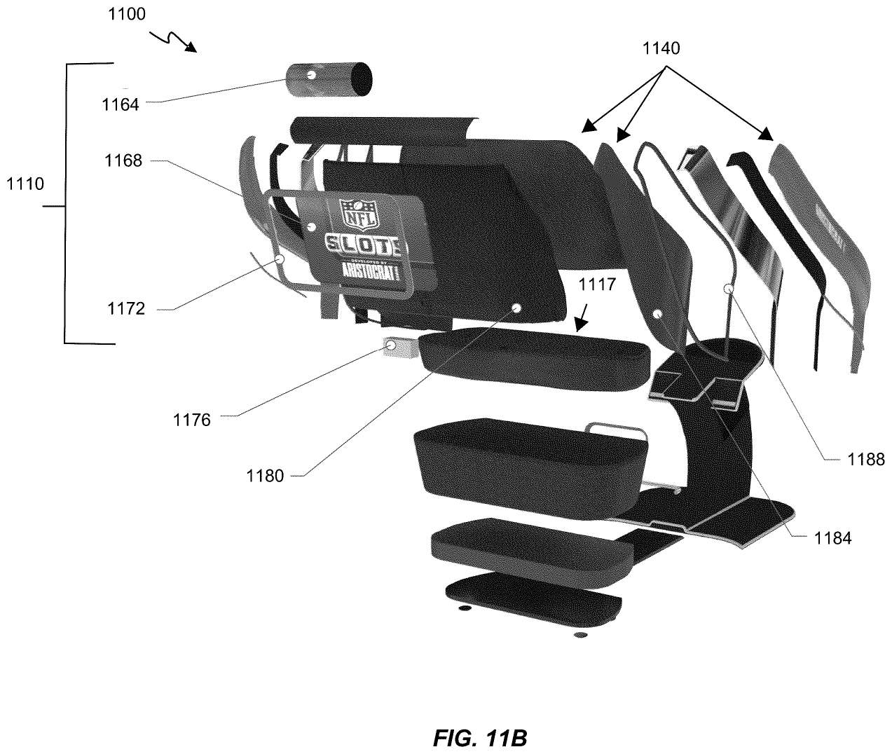

Although additional details and examples of seating systems having flexible displays are provided farther below, a few brief examples will now be provided. In one example, the seating system of FIGS. 4B and 4D has a seat 405 with a side panel 439 and a flexible display 436 on the side panel 439. The seat 405 also has an armrest 440 and a flexible display 420 on the armrest 440. In another example, the seating system of FIGS. 11A and 11B has a seat 1104 with a side panel 1184 having a curved flexible display thereon. The seat 1104 also has an armrest 1140 with multiple parts including a flexible curved display 1148 positioned thereon. In yet another example, referring back to FIGS. 12A-12F and 14, the seating system 1200 may have at least one flexible curved display panel on the armrest, side panel, or both. In FIG. 12E, a representative curved flexible display panel 1236 is illustrated, which is similar to flexible display panel 436 in FIG. 4B. This curved flexible display panel 1236 is represented by the dashed shape. The flexible display panel 1236 may have various shapes that follow the contours and shapes of the side panels. This may include curved flexible display panels with outer boundaries having linear and non-linear edges.

In some implementations, the seating systems provided herein are configured to display various images and/or videos on the flexible displays positioned on the side panels and/or armrests. These videos and/or images may be based on, or related to, events or aspects of a game played on the EGM communicatively connected to the seating system. For instance, a game outcome, a bonus game trigger, a bonus game outcome, a secondary game trigger, or a secondary game outcome may cause one or more images or videos to be displayed on the flexible displays of the seat. These images or videos may be related to the trigger and/or outcome of such games. In some implementations, these outcomes or triggers may collectively represent a “trigger condition” for a controller that is configured to control the operation of the flexible display to cause the display to display images and/or videos related to the outcome, trigger, or other event in the game. In some instances, this may include images or videos that are not displayed on the one or more displays of the EGM and only displayed on the flexible displays of the seat.

The trigger condition, e.g., outcomes or triggers in a game, may be transmitted from the game controller of the EGM to a controller of the seating system in various ways. In some instances, this trigger condition may be transmitted as an instruction to the controller of the seating system. In other instances, this trigger condition may be transmitted as data that the controller of the seating system receives, analyzes, and interprets in order to cause the flexible displays on the seat to display images or videos.

In one example, when a secondary or bonus game is triggered during gameplay of the EGM, one or more images or videos may be displayed on the flexible displays of the seat indicating that the secondary or bonus game has been triggered. In one example, when a game on the EGM having a theme with buffalos triggers a secondary game, images or videos of buffalos may be seen moving on the flexible displays of the seat. In another example, when a game on the EGM having a theme with dragons triggers a secondary game, images or videos of flames or dragons flying may be seen moving on the flexible displays of the seat. In yet another example, when a game on the EGM having a theme with fireworks triggers a secondary game, images or videos of fireworks exploding may be seen moving on the flexible displays of the seat. In another example, when a game on the EGM having a theme with a sports game, like football, baseball, basketball, soccer, or the like, triggers a secondary game, images or videos of the sports game may be depicted on the flexible displays of the seat.

In some implementations, the images or videos displayed on the flexible displays of the seat may indicate the achievement of triggering a secondary or bonus game, as well as winning one or more awards, games, or jackpots. The images or videos displayed on the flexible displays of the seat may therefore be caused to be displayed based on the triggering event. For example, when the secondary or bonus game is triggered, various images or videos displayed in the flexible displays of the seat may celebrate or indicate the celebration of this triggering which may enhance the celebration of such event. These images or videos may also catch the attention of persons and prospective players around the seat that the triggering has occurred on the EGM and may cause such persons to become players.

In some implementations, the images or videos displayed on the flexible displays of the seat may display information related to the game being played on the EGM. This information may be any of the game information provided herein. For example, the wager amounts available for the game, or the available jackpots, may be displayed on the flexible display on the side panel and/or armrest. This can advantageously present the game information in a larger format than on the EGM itself which can attract potential players to play the EGM.

In some implementations, the images or videos displayed on the flexible displays of the seat may display information unrelated to the game being played on the EGM. For example, advertisements or events in the building where the seat is located may be displayed. This may include advertisements for food or beverage discounts, or concerts and tournaments in the building.

Other aspects of the seating systems will now be discussed, such as the physical coupling or uncoupling between a seating system and an EGM. In some implementations, the seating systems provided herein may be physically separate, or physically uncoupled, from the displays of the EGM to which the seating system is communicatively connected. For example, referring to FIG. 15C, an electronic gaming system 1500 is provided that has a display 1511 of an EGM and three seating systems 1200 communicatively coupled to the EGM. Although the display of the EGM may have various shapes and sizes, the display 1511 here in FIG. 15C is a large wheel 1508 having an indicator 1512. In other implementations, the display may be differently shaped, sized, and spaced from the seating systems. In this example of FIG. 15C, the three seating systems 1200 are not physically coupled to the display 1511 of the EGM.

Other seating systems provided herein may also be physically uncoupled from, or not physically coupled to, an EGM. Referring back to the seating systems 1200 described above, such as those in FIGS. 12A-14, these seating systems may be considered physically uncoupled from, or not physically coupled to, the display of the EGM to which the seating system 1200 is communicatively coupled. In these instances, the EGM, including its displays, are physically separate, and physically uncoupled, from the seating system.

In some other implementations, the seating systems provided herein may be physically coupled with the displays of the EGM. This may include, for example, one or more EGM displays positioned on or coupled to one or more aspects of the seating system. Some examples are illustrated in FIGS. 16A-16C which depict seating systems with one or more EGM displays. In FIG. 16A, the seating system 1600A has an operating console 1616 and one display 1611 of the EGM physically coupled to the seating system 1600A, such as to the kiosk 1612. In FIG. 16B, the seating system 1600B has two displays 1611A and 1611B of the EGM physically coupled to the seating system 1600B, such as to the kiosk 1612. In FIG. 16C, the seating system 1600C has a different display 1611C of the EGM physically coupled to the seating system 1600C, such as to the kiosk 1612. Additional features of the seating system in FIGS. 16A-16C are provided below.

As noted herein, the seating system may have one or more controllers that are communicatively coupled with one or more game controllers of the EGM or gaming system. In some implementations, this communication coupling may be hardwired via one or more cables or wires, it may be a wireless connection, or both. This communication coupling is configured to transmit the player input received at the seating system, such as on the operating console 1216, to the game controller of the EGM. The game controller can use this player input from the seating system to execute one or more game instances. In some implementations, the one or more controllers of the seating system may also be configured to receive information and instructions from the game controller, such as information about the one or more game instances, like a trigger condition provided above. The one or more controllers of the seating system may cause, based on this information and/or instructions from the game controller, images and/or videos to be displayed on the flexible displays of the seat.

The subject disclosure also includes additional or alternative implementations and features of various seating systems, which are detailed below. Any of the following seating systems or seats may have any of the features of the seating systems described above. For example, benches, or seats, of seating systems 404, 405, 504, 604, 704, 804, 904, 1004, and 1104 may have the operating console provided above, such as the operating console 1216 illustrated in FIGS. 12A-14 and 17A-C.

The additional or alternative seating system implementations will now be discussed. Some of these implementations may refer to a “gaming bench” or “bench” and these phrases may be used synonymously with the term “seat”. Referring to FIGS. 4A-4G, these Figures illustrate different views of a seating system 400 with a first seat 404, which may also be considered a first gaming bench 404. The first seat 404 is in the form of a lounger style bench, and includes a number of amenities including one or more displays, projectors, and audio-visual devices to engage players or non-players for a better overall customer experience, while providing a variety of upgrade, reconfiguration, and modularity capabilities. As shown in FIG. 4A, the seat 404 provides an ability to connect to a new operating console and kiosk, such as those illustrated in FIGS. 12A-14 and 17A-17C, for example. The seat 404 is also configured to be a part of a seating system communicatively connected to a large LED wheel display of an electronic gaming system, as well as to a standard gaming cabinet of an EGM, such as those shown in FIG. 1.

Specifically, FIG. 4A shows that the seat 404 also includes one or more surround sound speakers 408 embedded in a backrest 410, and a subwoofer port 412 to reproduce or generate surround sounds and subwoofer bass. The backrest 410 may also include one or more hydraulic and/or acoustic mechanisms to produce vibration and/or massaging effects on the first gaming bench 404 that also may be synchronized with a game being played. In some examples, the backrest 410 may include RGB LED lit fabrics, thus embedding one or more RGB LED's. The RGB LEDs in the RGB LED lit fabrics may include configurable or controllable LED lighting patterns intended to match specific game characteristics. In the example shown, the first gaming bench 404 may have a width of about 49″, a height of about 41″, and a depth of 31″. Other dimensions are also possible. Various ergonomic controls and adjustments may be possible. Thus, the first gaming bench 404 may be able to accommodate one or more players. Further, although not shown, the first gaming bench 404 may include foldable cup holders that may be tucked away within the backrest 410.

The first gaming bench 404 also includes panels 416, 418, and 420. Panel 416 may be a side panel, panel 418 may be considered a front seat panel, and panel 420 may be an armrest. In some examples, some or all the panels 416, 418, and 420 may include colored plastic panels. In other examples, some or all the panels 416, 418, and 420 may include laminated wraps such as cherry wood panels. In some examples, some or all the panels 416, 418, and 420 may be configured to have, project, or display static colors and/or artworks. That is, some or all the panels 416, 418, and 420 may include electronic display panels to display video.

In some other implementations, as shown in FIG. 4B, another gaming bench 405 or seat 405 has side panels 439 (like panel 416) that may include one or more flexible display panels 436 contoured about an armrest 440, panel 420, and/or side panel 439. In FIG. 4B, reference numerals are used that refer to the same parts in other figures of FIGS. 4A AND 4C-4G. In some instances, the flexible displays 436 on the side panels 439 may be configured to display images, videos, game information or attractions, or a portion of the game being played. The seat 405 may also include a footrest 424. As shown, the seat 404 and seat 405 may be pivotably positioned on a swivel base 428.

In some implementations, the swivel base 428 may have a swivel angle 429 of 30° in two different directions. FIG. 4G shows the first gaming bench 404 may be configured to rotate to right, left, or both. In other examples, swivel base 428 may have other swivel angles, such as 45 degrees or 60 degrees. In some examples, the backrest 410 may recline with respect to the swivel base 428.

In the implementations of FIGS. 4A-4G, the seats 404 and 405 may also have a plug-and-play extension board 430 configured to couple to a cabinet, such as the main cabinet 116 of FIG. 1, a pedestal, a display, or a kiosk similar to kiosk 1212 described above. In some examples, the plug-and-play extension board 430, when coupled to the cabinet, pedestal, kiosk, or display, may interface data communications between the seat 404 or 405 and the cabinet, pedestal, kiosk, or display. For example, when the seat 404 or 405, cabinet, pedestal, kiosk, or display is configured to play a specific game with specific sound, the seat 404 or 405 may transmit data to flexible displays 436 on the side panels 439, the panels 418, 420, the surround sound speakers 408, the backrest 410, and the subwoofer port 412 for further manifestation of the specific game and sound.

In some instances, at least a portion of the data transmitted to control flexible displays 436 on the side panels 439, the panels 418, 420, the surround sound speakers 408, the backrest 410, and the subwoofer port 412 may be received from the cabinet, pedestal, kiosk, or display. In some examples, the seat 404 or 405 may include some or all the components in the cabinet such as the main cabinet 116 of FIG. 1. In such cases, when coupled to the seat 404 or 405, the kiosk may simply provide display functionalities, while the seat 404 or 405 may provide processing and communication functionalities similar to those discussed above with respect to FIGS. 1 and 2. That is, the seat 404 or 405 may include a bill validator (similar to the bill validator 234 of FIG. 2), a player tracking device (similar to the player tracking interface 232), one or more secondary display device, and the like, detailed below.

Referring to FIG. 4C, the seat 404 may also include a display panel 444 configured to display game information, game offerings, and/or a game being played. In some examples, the display panel 444 may include flexible liquid crystal display (LCD) displays, flexible electrophoretic display (EPD) displays, and flexible organic light emitting diode (OLED) displays, rollable TFT-driven OLED displays, electronic paper displays, and the like. In some examples, the display panel 444 may also include RGB LED surround lighting. In other examples, display panel 444 may include one or more immersive LCD screens. Other displays are also envisioned. As shown, the first gaming bench 404 may also include a high-definition projector 448 operable to project customizable game information. In some examples, the first gaming bench 404 may also include RGB LED lighting about the armrest 440 and the swivel base 428.

Similarly, in FIG. 4D, the seat 405 includes RGB lighting displays 436 on the side panels 439 that may include one or more flexible display panels contoured about the armrest 440 and configured to display game information or attractions, or a portion of the game being played. The seat 404 or 405 may also include a secondary display device 456. In some examples, the secondary display device 456 may include a custom tube display with RGB LED lighting. In some other examples, the secondary display device 456 may include a 3-D holographic LED tube. In still other examples, the secondary display device 456 may include a flexible display. In some examples, the secondary display device 456 may display at least a portion of the game being played in the seating system 400, or other gaming information.

FIGS. 4E and 4F show a front and side view, respectively, of another variation of the seat 404 and 405 which may have the same or similar features as that of FIGS. 4A-4D.

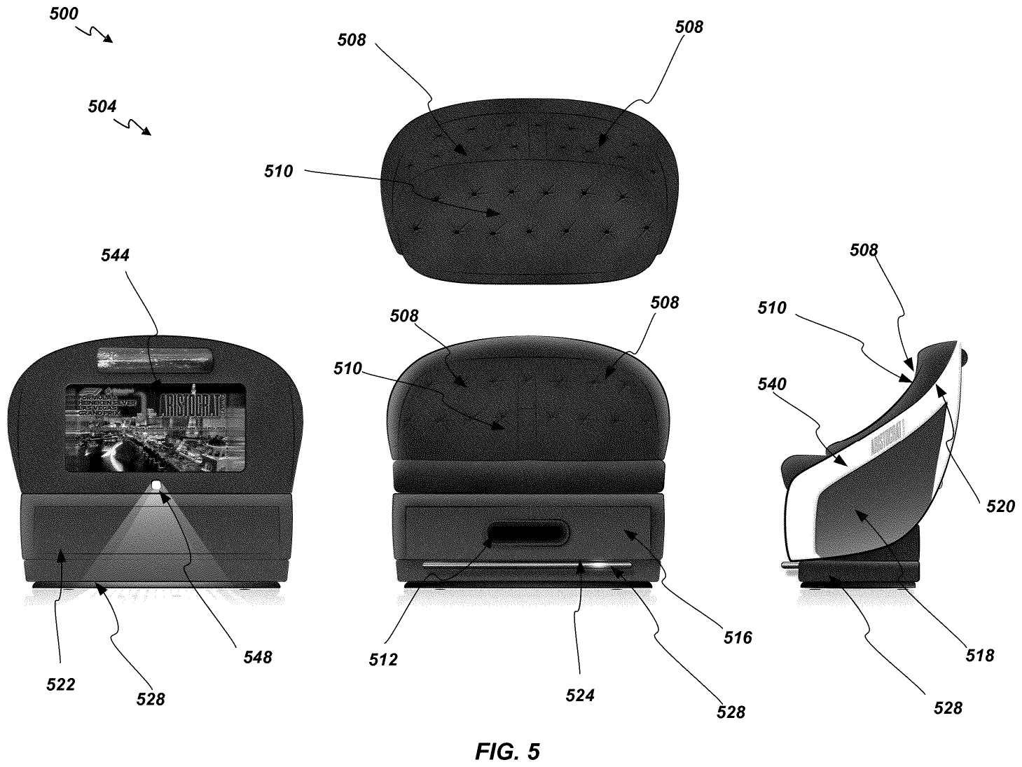

FIG. 5 illustrates different views of a second version of a seating system 500. Similar to FIGS. 4A-4G, the last two numbers of each reference numeral refer to the same features with reference numerals having the same last two numbers in other figures (e.g., backrest 510 of FIG. 5 corresponds with backrest 410 of FIGS. 4A-4G). Like with seat 404 or 405, the seating system 500 of FIG. 5 includes an integrated modular gaming bench or seat, or a second gaming bench or seat 504. The second seat 504 also includes one or more surround sound speakers 508 embedded in a backrest 510, and a subwoofer port 512 to reproduce or generate surround sound and subwoofer bass. The backrest 510 may also include one or more acoustic and/or hydraulic mechanisms to produce vibration effects that may be synchronized with a game being played.

Like the backrest 410 in FIG. 4A, the backrest 510 may also include RGB LED lit fabrics. In the example shown, the second gaming bench 504 may have a width of about 45″, a height of about 40″, and a depth of 29″. Thus, the second gaming bench 504 may be able to accommodate one or more players. Further, although not shown, the second gaming bench 504 may include foldable cup holders that may be tucked away within the backrest 510.

The second gaming bench 504 also includes front panel 516, side panel 518 (which may have one or more curved flexible displays positioned thereon), armrest panel 520 (which may also have one or more curved flexible displays positioned thereon), and back panel 522. The armrest panel 520 is similarly configured to contour around the backrest 510. However, unlike panel 420 of FIG. 4A, the armrest panel 520 does not wrap around toward the front panel 516. In some other examples, the armrest panel 520 is contoured about an armrest 540 and configured to display game information or attractions, or a portion of the game being played. The second gaming bench 504 also includes a footrest 524. As shown, the second seat 504 is pivotally positioned on a swivel base 528. Although not shown, the second gaming bench 504 also includes a plug-and-play extension board (like the plug-and-play extension board 430 of FIG. 4A) to be coupled to a cabinet such as the main cabinet 116 of FIG. 1, or kiosk as detailed herein. The second seat 504 may also include an LED display 544 (like the display panel 444 of FIG. 4C) configured to display game information, game offerings, and/or a game being played. The second gaming bench 504 may also include a high-definition projector 548 (like the high-definition projector 448 of FIG. 4C). In some examples, the backrest 510 may recline with respect to the swivel base 528.

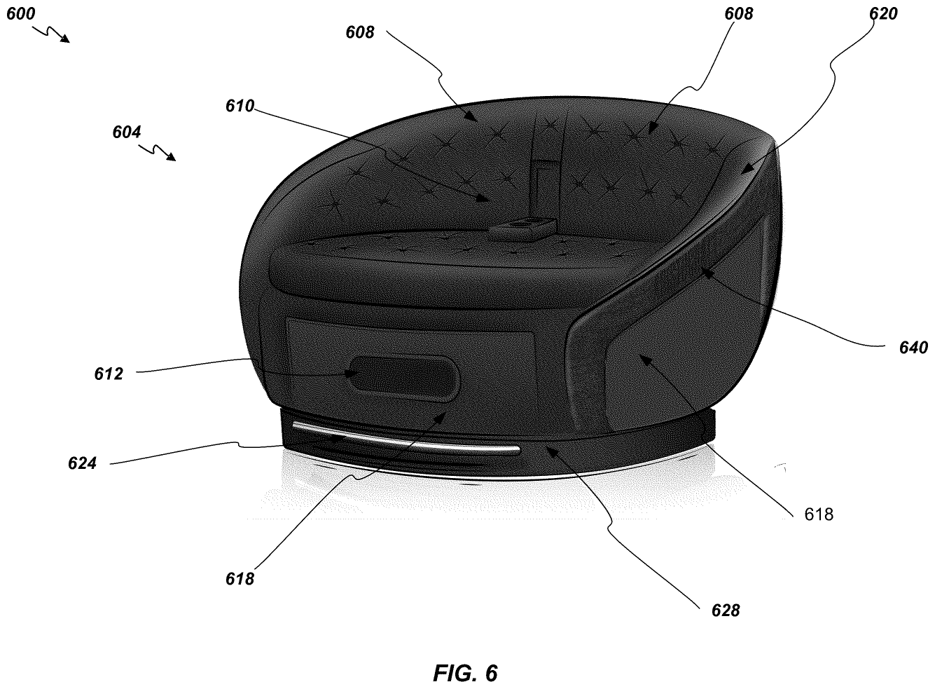

FIG. 6 illustrates a third version of a seating system 600. Again, the last two numbers of each reference numeral refer to the same features with reference numerals having the same last two numbers in other figures (e.g., backrest 610 of FIG. 6 corresponds with backrest 410 of FIGS. 4A-4G). Like the first gaming bench 404, the seating system 600 includes an integrated modular gaming bench, or a third gaming bench 604 or seat 604. The third gaming bench 604 also includes one or more surround sound speakers 608 embedded in a backrest 610, and a subwoofer port 612 to reproduce or generate surround sounds and subwoofer bass. The backrest 610 may also include one or more acoustic and/or hydraulic mechanisms to produce vibration or massaging effects that may be synchronized with a game being played.

Like the backrest 410 in FIG. 4A, the backrest 610 may also include RGB LED lit fabrics. The third gaming bench 604 may be able to accommodate one or more players. Further, although not shown, the third gaming bench 604 may include foldable cup holders that may be tucked away within the backrest 610. The third seat 604 also includes front panel 616, side panel 618 (which may have one or more curved flexible displays positioned thereon), and armrest panel 620 (which may have one or more curved flexible displays positioned thereon). Armrest panel 620 is similarly configured to contour around the backrest 610. In some other examples, a flexible display panel is contoured about an armrest 640 and configured to display game information or attractions, or a portion of the game being played. The third gaming bench 604 also includes a footrest 624. As shown, the third gaming bench 604 is pivotally positioned on a swivel base 628. Although not shown, the third gaming bench 604 also includes a plug-and-play extension board (like the plug-and-play extension board 430 of FIG. 4A) to be coupled to a cabinet such as the main cabinet 116 of FIG. 1, or kiosk as detailed herein. Although not shown, the third gaming bench 604 may also include a flexible display on a side panel, armrest, or both (similar to the display panel 436 of FIG. 4D) configured to display game information, game offerings, and/or a game being played, and a high-definition projector (similar to the high-definition projector 448 of FIG. 4C). In some examples, the backrest 610 may recline with respect to the swivel base 628.

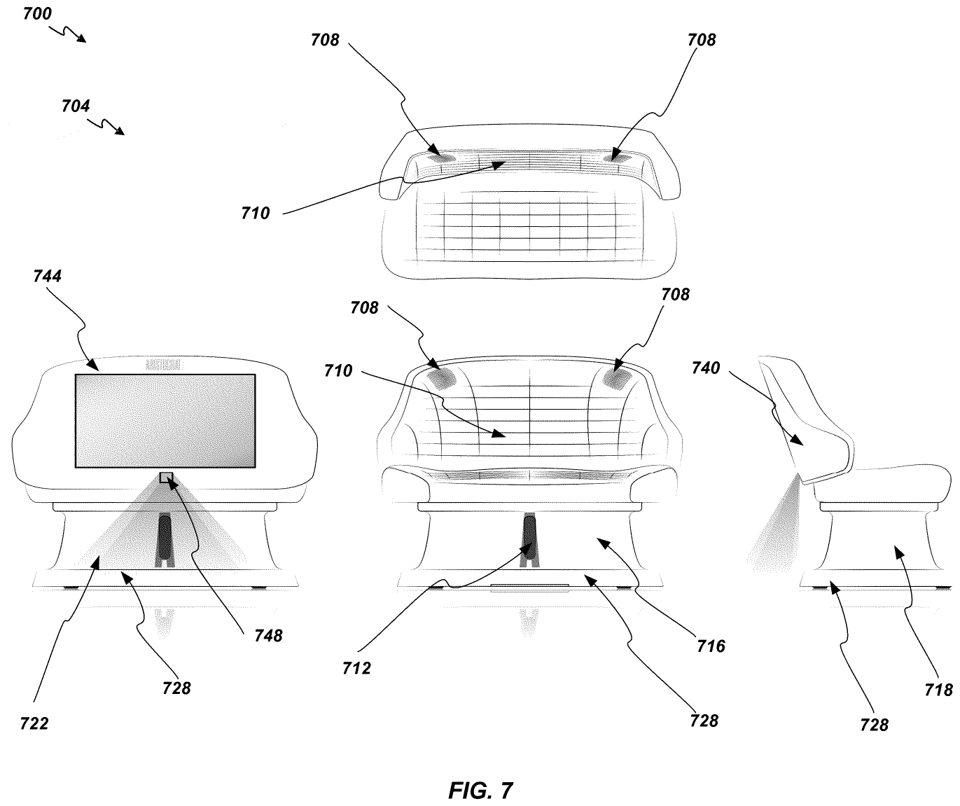

FIG. 7 illustrates different views of a seating system 700. Here, the last two numbers of each reference numeral refer to the same features with reference numerals having the same last two numbers of other figures (e.g., backrest 710 of FIG. 7 corresponds with backrest 410 of FIGS. 4A-4G). Like the first seat 404, the seating system 700 includes an integrated modular gaming bench, or a fourth gaming bench 704 or seat 704. The fourth gaming bench 704 includes one or more surround sound speakers 708 embedded in a backrest 710, and a subwoofer port 712 to reproduce or generate surround sound and subwoofer bass. The backrest may also include RGB LED lit fabrics. In the example shown, the fourth gaming bench 704 may accommodate one or more players. Further, although not shown, the fourth gaming bench 704 may include foldable cup holders that may be tucked away within the backrest 710. The fourth gaming bench 704 also includes front panel 716, side panel 718, armrest panel 720, and back panel 722. The armrest panel 720 is similarly configured to contour around the backrest 710. In some other examples, the armrest panel 720 has one or more curved flexible displays positioned thereon, is contoured about an armrest 740, and is configured to display game information or attractions, or a portion of the game being played. The fourth gaming bench 704 is pivotably positioned on a swivel base 728.

Although not shown, the fourth seat 704 also includes a plug-and-play extension board (like the plug-and-play extension board 430 of FIG. 4A) to be coupled to a cabinet such as the main cabinet 116 of FIG. 1, or kiosk as detailed herein. The fourth gaming bench 704 may also include an LED display 744 (like the display panel 444 of FIG. 4C) configured to display game information, game offerings, and/or a game being played. In some examples, the LED display 744 includes a 27″ 4K high resolution LCD or LED display panel. The fourth gaming bench 704 may also include a high-definition projector 748 (like the high-definition projector 448 of FIG. 4C) to display different gaming device information and/or games being offered. In some examples, the backrest 710 may recline with respect to the swivel base 728.

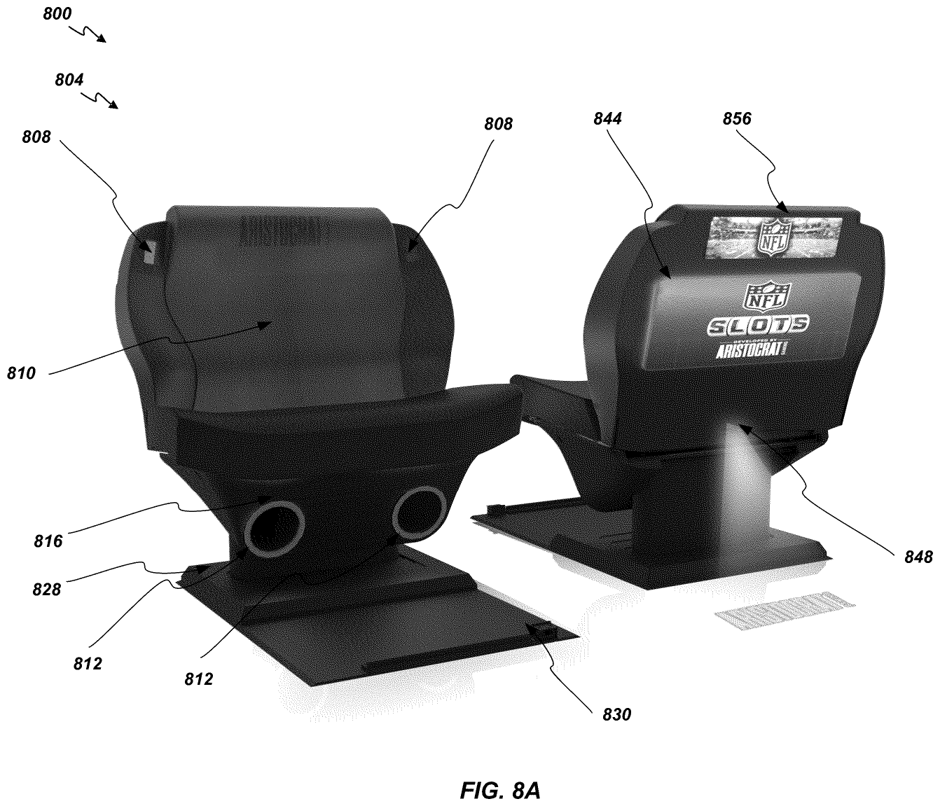

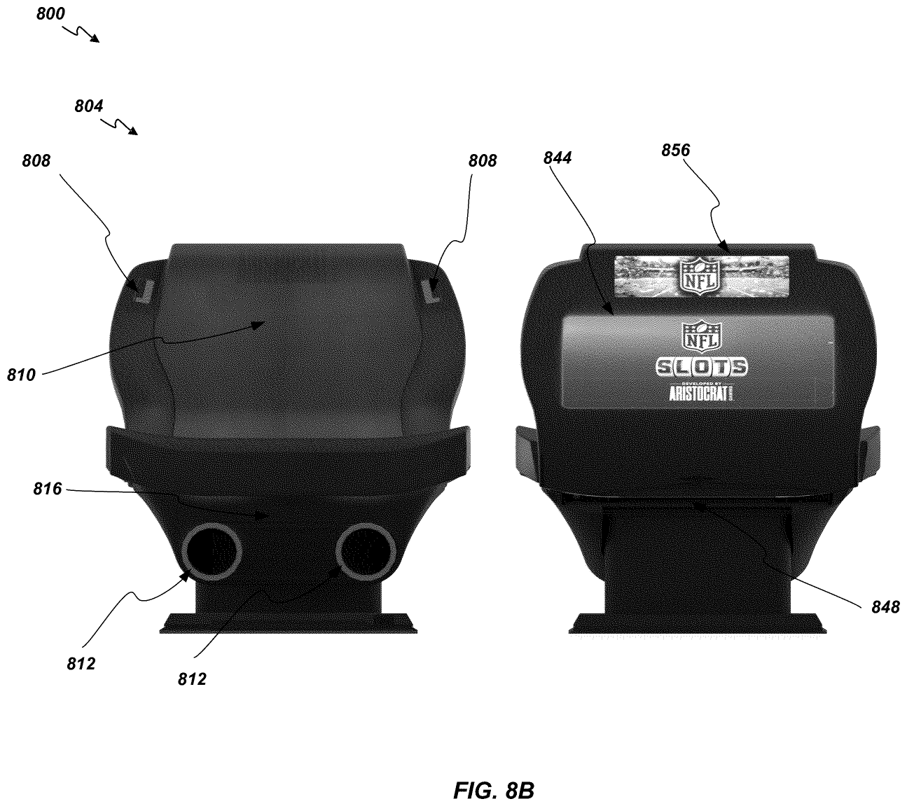

FIGS. 8A and 8B depict yet another example seating system 800. Here again, the last two numbers of each reference numeral refer to the same features with reference numerals having the same last two numbers of other figures (e.g., backrest 810 of FIG. 8A corresponds with backrest 410 of FIGS. 4A-4G). Like the first gaming bench 404, the seating system 800 includes an integrated modular gaming bench, or a fifth gaming bench 804 or seat 804. The fifth gaming bench 804 is a three-quarter style bench that includes a pair of surround sound speakers 808 embedded in a backrest 810, and a pair of subwoofer ports 812 to reproduce or generate surround sound and subwoofer bass. The backrest 810 may also include one or more acoustic and/or hydraulic mechanisms (not shown) to move the gaming bench 804 in various directions and/or to produce vibration or massaging effects that may be synchronized with a game being played. Like the backrest 410 in FIG. 4A, the backrest 810 may also include RGB LED lit fabrics. In the example shown, the fifth gaming bench 804, although not shown, may also include foldable cup holders that may be tucked away within the backrest 810.

The fifth gaming bench 804 also includes front panel 816 that supports the pair of subwoofer ports 812. As shown, the fifth gaming bench 804 may be pivotably positioned on a swivel base 828. The fifth gaming bench 804 also includes a plug-and-play extension board 830 (like the plug-and-play extension board 430 of FIG. 4A) to be coupled to a cabinet such as the main cabinet 116 of FIG. 1, or kiosk as detailed herein. The fifth gaming bench 804 may also include an LED display 844 (like the display panel 444 of FIG. 4C) configured to display game information, game offerings, and/or a game being played from the back of the fifth gaming bench 804.

The fifth seat 804 may also include a high-definition projector 848 (like the high-definition projector 448 of FIG. 4C). The high-definition projector 848 is depicted displaying images or videos downward, but it may display images or videos in other directions. As shown, the fifth gaming bench 804 may also include a secondary display device 856 (like the secondary display device 456 of FIG. 4A), that may include a combination of a custom tube display with RGB LED lighting, a 3-D holographic LED tube, a flexible display, and the like. In some examples, the secondary display device 856 may display at least a portion of the game being played in the seating system 800, or other gaming information. In some examples, the backrest 810 may recline with respect to the swivel base 828.

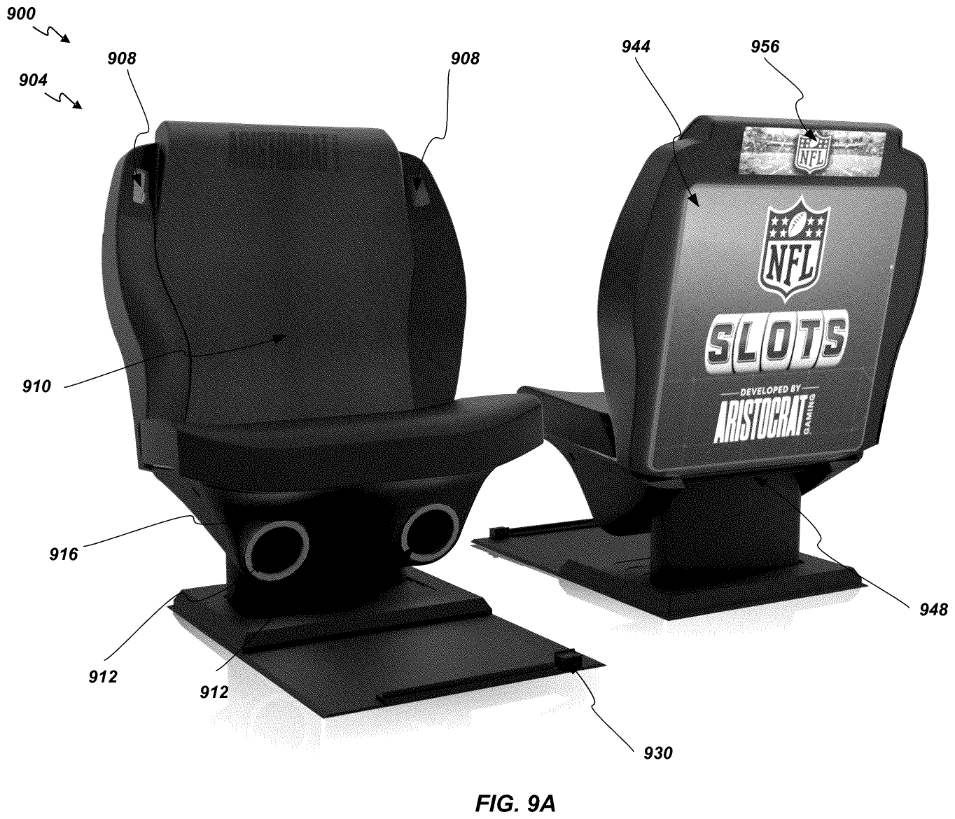

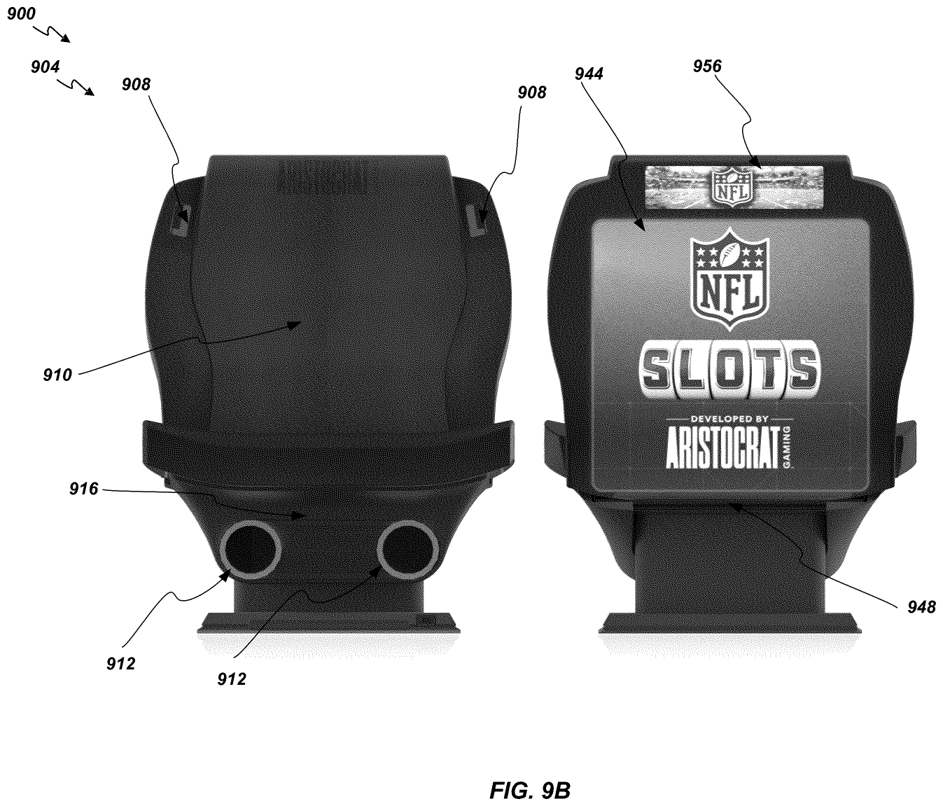

FIGS. 9A and 9B depict another example seating system 900. Here again, the last two numbers of each reference numeral refer to the same features with reference numerals having the same last two numbers of other figures (e.g., backrest 910 of FIG. 9A corresponds with backrest 410 of FIGS. 4A-4G). Like the seating system 800 illustrated in FIGS. 8A and 8B, the seating system 900 includes an integrated modular gaming bench, or a sixth gaming bench 904 or seat 904. The sixth gaming bench 904 is a full-size bench (unlike the three-quarter bench of FIG. 8A), sometimes referred to as a high boy bench, that includes a pair of surround sound speakers 908 embedded in a backrest 910, and a pair of subwoofer ports 912 on front panel 916 to reproduce or generate surround sound and subwoofer bass. The backrest 910 may also include one or more acoustic and/or hydraulic mechanisms (not shown) to produce vibration or massaging effects that may be synchronized with a game being played.

Like the backrest 410 in FIG. 4A, the backrest 910 may also include RGB LED lit fabrics. In the example shown, the sixth gaming bench 904, although not shown, may also include foldable cup holders that may be tucked away within the backrest 910. The sixth gaming bench 904 also includes a plug-and-play extension board 930 (like the plug-and-play extension board 430 of FIG. 4A) to be coupled to a cabinet such as the main cabinet 116 of FIG. 1, or kiosk as detailed herein. The sixth seat 904 may also include an LED display 944 (like the display panel 444 of FIG. 4C) configured to display game information, game offerings, and/or a game being played from the back of the sixth gaming bench 904. The sixth gaming bench 904 may also include a high-definition projector 948 (like the high-definition projector 448 of FIG. 4C), and a secondary display device 956 (like the secondary display device 456 of FIG. 4A). In some examples, the secondary display device 956 may display at least a portion of the game being played in the seating system 900, or other gaming information.

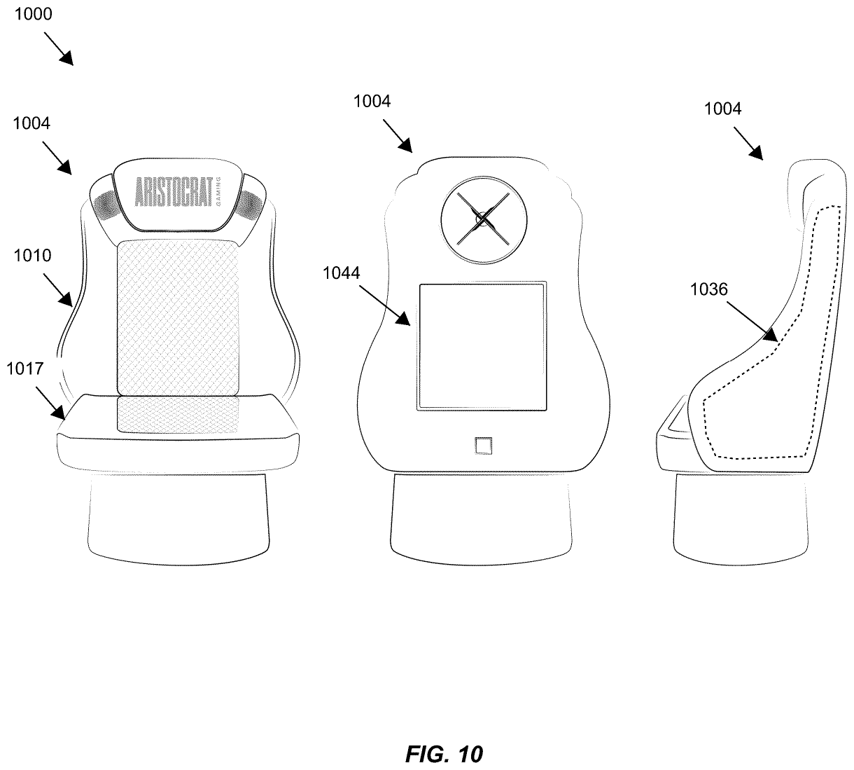

FIG. 10 depicts yet another example seating system 1000. Here, the last two numbers of each reference numeral refer to the same features with reference numerals having the same last two numbers of other figures (e.g., backrest 1010 of FIG. 10 corresponds with backrest 410 of FIGS. 4A-4G). The seat 1004 of seating system 1000 has a backrest 1010, a seating surface 1017, and one or more flexible displays, such as display 1044 on the backrest 1010 or a flexible display 1036 on the side panel of the seat 1004.

FIGS. 11A and 11B depict another example seating system 1100. Here, the last two numbers of each reference numeral refer to the same features with reference numerals having the same last two numbers of other figures (e.g., backrest 1110 of FIG. 11A corresponds with backrest 410 of FIGS. 4A-4G). These FIGS. 11A and 11B illustrate exploded views of seating system 1100 including a seat 1102 and a kiosk 1112 that may be coupled to a plug-and-play extension board 1108 (like the plug-and-play extension board 430 of FIG. 4A). In the example shown, the kiosk 1112 may also be communicatively coupled to a display device that displays a game being played. The kiosk 1112 may include a button deck (such as, for example, the button deck 120 of FIG. 1 and operating console 1216 with button deck 1223 provided above). In some instances, the kiosk 1112 may be physically coupled to the display of the EGM or physically uncoupled from the display of the EGM. In still further examples, the kiosk 1112 may integrated on a track system or the like (not shown) to permit the lateral movement of the kiosk 1112, while allowing the seating system 1100 to be a singular or modular unit. The movement of the kiosk 1112 toward, away, around or some combination of movements from the seat 1104 may facilitate player egress and/or improve ergonomics (e.g., reduce fatigue, increase comfort, etc.) for the player during operation.

FIG. 11A illustrates a front exploded perspective view of a bench 1104, which may also be considered a seat 1104 upon which one or more players may be seated, such as on a seating surface 1117, like a seat pan, where a player may sit down. The seating surface 1117 is configured to support a player's buttocks. The seat 1104 may have fabrics 1116 embedded with RGB lighting (not shown). The fabrics 1116 may include full grain leather, boucle, chenille, Cryton, denim, canvas, linen, Matelasse, microfiber, micro-suede, and the like. In the example shown, seat 1104 may be supported by a swivel base 1120 (like the swivel base 428 of FIG. 4A) with a bottom base 1124 and a bottom plate 1128 having a number of adjustable lever feet 1132. In other examples, seat 1104 may be supported by a fixed base (not shown) with the bottom base 1124 and the bottom plate 1128 having the adjustable lever feet 1132. As shown, seat 1104 also includes a footrest 1136 extending from the swivel base 1120. Further, the swivel base 1120 may include one or more subwoofer ports (like the subwoofer port 412 of FIG. 4A) that may include a vacuum formed acrylic cover 1140 lit with RGB LED. The seat also has a backrest 1110 connected to and adjacent to the seating surface 1117.

In the example shown, seat 1104 may be surrounded by a number of panels including a reflective backplate 1144 covered by a flexible panel 1148 that may include a flexible LED panel 1148, a flexible RGB panel, and the like. A vacuum formed acrylic panel 1152 is installed on top of the flexible panel 1148. The vacuum formed acrylic panel 1152 may be translucent, clear, solid, and/or reflective. Further, seat 1104 may be lit with a controlled light strip 1156. In some examples, seat 1104 may include a branding option 1160.

FIG. 11B illustrates a back exploded perspective view of seat 1104. As shown, seat 1104 includes a siren style lighting tube 1164 (like the secondary display device 456 of FIG. 4C). The siren style lighting tube 1164 may include a hologram tube, a transparent 12:3 OLED screen, a flexible LED panel, a backlit graphic or artwork, and the like. The seat 1104 also includes a an LED display 1168 (like the display panel 444 of FIG. 4C) operable to display game information, game offerings, and/or a game being played. The LED display 1168 may include one of a flexible LED panel, an immersive LCD panel, an LCD display, a backlit graphic or artwork, and the like. As shown, the LED display 1168 is shielded by a cover 1172 that may include a vacuum formed acrylic cover with RGB LED's, which may also be translucent, clear, solid color, and/or reflective. Seat 1104 also includes an optional high-definition projector 1176 (like the high-definition projector 448 of FIG. 4C) to display different gaming device information and/or games being offered, as discussed. The seat 1104 also includes a back panel 1180 (like the back panel 522 of FIG. 5), and a side panel 1184 (like the side panel 518 of FIG. 5) covered by a side panel rail 1188 and that may have a curved flexible display.

FIGS. 15A-15C depict another example seating system 1500. The electronic gaming system 1500 includes a plurality of seating systems 1200 (like the seating system 1200 in FIGS. 12A-12F or seating system 1400 in FIG. 14) arranged for playing a group game. In this example, the seating systems 1200 are facing a giant wheel 1508 with an indicator 1512. Although FIGS. 15A-15C show that the giant wheel 1508 as a physical wheel, the giant wheel 1508 may also be a projected wheel projected from the front projector 1252 (of FIG. 12A), or a combination of the front projectors 1252 (of FIG. 12C). The physical wheel could take the form of a different shaped display device.

FIGS. 16A-16C depict another example seating system 1600. Here, the last two numbers of each reference numeral refer to the same features with reference numerals having the same last two numbers of other figures (e.g., operating console 1616 of FIG. 16A corresponds with operating console 121 of FIGS. 12A-12F). FIG. 16A includes an electronic gaming system 1600A comprising a kiosk 1612 comprising a operating console 1616 and a power meter display 1611A. FIG. 16B is another configuration of the electronic gaming system 1600B comprising a kiosk 1612 comprising an operating console 1616, a power meter display 1611A, and a game display unit 1611B, which is illustrated as a mini-wheel unit, where the kiosk 1612, a power meter display 1611A, and a game display unit 1611B are integrated a single modular assembly that can easily reconfigured to add, remove or replace parts of the assembly. FIG. 16C is like the example of FIG. 16B and illustrates an electronic gaming system 1600C further comprising a game display unit 1611C, which is illustrated as a wonder wheel unit. The electronic gaming systems 1600A-1600C may also be integrated into a single unit that may be moved as a single unit, e.g., on wheels or tracks. Such an arrangement may permit an improved ability to replace one or more electronic gaming systems 1600A-1600C on gaming establishment floors. As provided herein, the seating systems 1600A-1600C may have other displays of the EGM, such as rectangular or curved displays similar to those illustrated in FIG. 1 above.

When an element, such as a layer, is referred to as being “on,” “connected to,” or “coupled to” another element, it may be directly on, directly connected to, or directly coupled to the other element or at least one intervening element may be present. When, however, an element is referred to as being “directly on,” “directly connected to,” or “directly coupled to” another element, there are no intervening elements present. Other terms and/or phrases if used herein to describe a relationship between elements should be interpreted in a like fashion, such as “between” versus “directly between,” “adjacent” versus “directly adjacent,” “on” versus “directly on,” etc. Further, the term “connected” may refer to physical, electrical, and/or fluid connection.

For the purposes of this disclosure, “at least one of X, Y, . . . , and Z” and “at least one selected from the group consisting of X, Y, . . . , and Z” may be construed as X only, Y only, . . . , Z only, or any combination of two or more of X, Y, . . . , and Z, such as, for instance, XYZ, XYY, YZ, and ZZ. As used herein, the term “and/or” includes any and all combinations of one or more of the associated listed items.

Although the terms “first,” “second,” “third,” etc., may be used herein to describe various elements, these elements should not be limited by these terms. These terms are used to distinguish one element from another element. Thus, a first element discussed below could be termed a second element without departing from the teachings of the disclosure. To this end, use of such identifiers, e.g., “a first element,” should not be read as suggesting, implicitly or inherently, that there is necessarily another instance, e.g., “a second element.” Further, the use, if any, of ordinal indicators, such as (a), (b), (c), . . . , or (1), (2), (3), . . . , or the like, in this disclosure and accompanying claims, is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated), unless indicated otherwise. For example, if step (ii) involves the handling of an element that is created in step (i), then step (ii) may be viewed as happening at some point after step (i). In a similar manner, if step (i) involves the handling of an element that is created in step (ii), the reverse is to be understood.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's spatial relationship to at least one other element as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” or “over” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The term “between,” as used herein and when used with a range of values, is to be understood, unless otherwise indicated, as being inclusive of the start and end values of that range. For example, between 1 and 5 is to be understood as inclusive of the numbers 1, 2, 3, 4, and 5, not just the numbers 2, 3, and 4.

As used herein, the phrase “operatively connected” is to be understood as referring to a state in which two components and/or systems are connected, either directly or indirectly, such that, for example, at least one component or system can control the other. For instance, a controller may be described as being operatively connected with (or to) a resistive heating unit, which is inclusive of the controller being connected with a sub-controller of the resistive heating unit that is electrically connected with a relay that is configured to controllably connect or disconnect the resistive heating unit with a power source that is capable of providing an amount of power that is able to power the resistive heating unit so as to generate a desired degree of heating. The controller itself likely will not supply such power directly to the resistive heating unit due to the current(s) involved, but it is to be understood that the controller is nonetheless operatively connected with the resistive heating unit.

As used herein, the singular forms, “a,” “an,” and “the” are intended to include the plural forms as well, unless the context clearly indicates otherwise. It is also to be understood that the phrases “for each <item> of the one or more <items>,” “each <item> of the one or more <items>,” and/or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in itself, as necessarily encompassing a plurality of items—it is to be understood that a set or a subset can encompass only one member or multiple members (unless the context indicates otherwise). In addition, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A seating system for electronic gaming on an electronic gaming machine, the seating system comprising:
a seat with a seating surface and a backrest;
a kiosk directly or indirectly coupled to the seat; and
an operating console rotatably coupled to the kiosk and having:
a button deck,
a first end piece detachably coupled to a first end of the operating console and having a first button, and
a second end piece detachably coupled to a second end of the operating console, opposite the first end, and having a second button or a display, wherein:
the first end piece and the second end piece are configured to be detached from the operating console,
the operating console is configured to receive a third end piece at the first end or the second end when the first end piece or the second end piece, respectively, has been detached,
the operating console is configured to be rotated between a first orientation and a second orientation 90 degrees apart from the first orientation, and
the button deck, the first end piece, and the second end piece are configured to be communicatively coupled to a game controller of the electronic gaming machine.

2. The system of claim 1, wherein the button deck, the first end piece, the second end piece, or a combination thereof are configured to:
receive input from a user, and
provide information related to the input from the user to the game controller of the electronic gaming machine.

3. The system of claim 1, wherein the operating console is further configured to translate along a translation axis.

4. The system of claim 3, wherein the translation axis is perpendicular to the axis of rotation.

5. The system of claim 3, wherein the operating console is configured to translate along the translation axis without the use of tools.

6. The system of claim 3, wherein:
the translation axis has a first end and a second end,
the second end is closer to the seat than the first end, and
the operating console is closer to the seat when positioned at the second end than when positioned at the first end.

7. The system of claim 1, wherein the second end piece is oriented at a non-parallel angle with respect to the button deck.

8. The system of claim 1, wherein the first button is a physical button.

9. The system of claim 1, wherein the second end piece has a display that is configured to display player related information.

10. The system of claim 1, further comprising:
a display of the electronic gaming machine coupled to the kiosk and/or the seat, and
the game controller that is configured to cause a game instance to be displayed on the display.

11. The system of claim 1, wherein the electronic gaming machine is without any physical coupling to the seat or the kiosk.

12. The system of claim 1, wherein the seat further comprises at least one display panel configured to display game information, attractions, a portion of a game instance, images, videos, or a combination thereof.

13. The system of claim 12, further comprising a controller communicatively coupled with the game controller, wherein the controller is configured to display, based on an outcome of a game instance on the electronic gaming machine, game information, attractions, a portion of a game instance, images, videos, or a combination thereof.

14. The system of claim 13, wherein the game information, attractions, a portion of a game instance, images, videos, or a combination thereof displayed based on the outcome of the game instance is related to a game theme of the game instance.

15. The system of claim 12, wherein the game information includes one or more wager amounts of the game instance.

16. The system of claim 12, wherein:
the at least one display panel comprise one or more curved flexible display panel,
the seat further includes at least one side panel adjacent to the seating surface and the backrest, and
the curved flexible display panel is positioned on the side panel.

17. The system of claim 16, wherein the curved flexible display panel comprises a flexible liquid crystal display (LCD), a flexible electrophoretic display (EPD), a flexible organic light emitting diode (OLED) display, a rollable TFT-driven OLED display, or an electronic paper display.

18. The system of claim 16, wherein:
the side panel includes an armrest, and
the curved flexible display panel is positioned on the armrest.

19. A seating system for electronic gaming on an electronic gaming machine, the seating system comprising:
a seat with a seating surface, a backrest, and at least one armrest adjacent to the seating surface and the backrest;
at least one flexible curved display panel on the at least one armrest;
a kiosk directly or indirectly coupled to the seat; and
an operating console coupled to the kiosk and having a button deck configured to be communicatively coupled to a game controller of the electronic gaming machine, wherein the at least one flexible curved display panel is configured to display game information, attractions, a portion of a game instance, images, videos, or a combination thereof.

20. The system of claim 19, further comprising a controller communicatively coupled with the game controller, wherein the controller is configured to display, based on an outcome of a game instance on the electronic gaming machine, the game information, attractions, a portion of a game instance, images, videos, or a combination thereof.
